(19) United States
(12) Patent Application Publication
(10) Pub. No.: US 2009/0286176 A1
(43) Pub. Date: Nov. 19, 2009

(54) ELECTROPHOTOGRAPHIC COLOR TONER

(75) Inventors: Ken OHMURA, Tokyo (JP); Tomomi OSHIBA, Tokyo (JP); Kishio TAMURA, Tokyo (JP); Nagayuki UEDA, Tokyo (JP)

Correspondence Address: LUCAS & MERCANTI, LLP, 475 PARK AVENUE SOUTH, 15TH FLOOR, NEW YORK, NY, 10016, US

(73) Assignee: KONICA MINOLTA BUSINESS TECHNOLOGIES, INC., Tokyo (JP)

(21) Appl. No.: 12/427,300

(22) Filed: Apr. 21, 2009

(30) Foreign Application Priority Data
May 16, 2008 (JP) 2008129351

(51) Int. Cl. G03G 9/08

(52) U.S. Cl. 430/107.1

(57) ABSTRACT

A set of a yellow toner, a magenta toner, a cyan toner and a black toner is disclosed. Each of the color toners contains a colored particle and cerium oxide particles, the colored particle containing an amorphous polyester resin, a crystalline polyester resin, a colorant and a releasing agent; and the yellow toner contains C.I. Pigment Yellow 74, the magenta toner contains C.I. Pigment Red 122 and C.I. Pigment Red 238, the cyan toner contains any one of C.I. Pigment Blue 15:1, C.I. Pigment Blue 15:2 and C.I. Pigment Blue 15:3, and the black toner contains carbon black and any one of C.I. Pigment Blue 15:1, C.I. Pigment Blue 15:2 and C.I. Pigment Blue 15:3.

This application is based on Japanese Patent Application No. 2008-129351 filed on May 16, 2008, in Japanese Patent Office, the entire content of which is hereby incorporated by reference.

### TECHNICAL FIELD

The invention relates to an electrophotographic color toner as well as a color image forming method.

### TECHNICAL BACKGROUND

Recently, color image forming apparatuses capable of outputting high quality color image at high speed have been appeared in the field of electrophotographic image forming apparatus. Such the color forming apparatuses are superior for making prints having revisable information such as direct mails, customized catalogs or leaflets. Moreover, the apparatuses begin to be spread as alternate of offset printing machines which are main stream of commercial printing and apparatuses so called as digital printing machine are appeared since any printing plate is not needed in such the apparatuses.

It is necessary to solve a problem of fixation by heating for developing the color image forming apparatus to the “digital printing machine”. In concrete, the problem is caused by that curling tends to be caused by evaporation of moisture from the paper when toner images formed on printing paper for offset printing is subjected to the heating fixation because the paper for offset printing is designed for raising the affinity with water. Consequently, it is necessary to inhibit evaporation of moisture from the paper as small as possible so that a technique of low-temperature fixation corresponding to more severe condition is required from such the viewpoint. Particularly, a method is demanded by which printing can be carried out without speed lowering even when thick paper having high weight is used which is difficultly fixed by heating.

Moreover, high level of quality is also required to the print formed by toner image. For example, high image quality having high glossiness and wide color region is required when the catalogues or leaflets are printed. Namely, toner images are required which have quality being not inferior at all to that obtained by usual printing technology.

Trials have been progressed for solving such subjects of raising the glossiness and expanding the color region from the viewpoint of design of the toner. Among them, design of toner suitable for the low-temperature fixing utilizing an emulsion polymerization-coagulation method is proposed, cf. Patent Documents 1 and 2, for example. Concretely, a toner producing method is proposed, which is constituted by a core using a binder resin having relatively low glass transition temperature suitable for low-temperature fixation and a shell using a binder resin having relatively high glass transition temperature. The method of the above Patent Document 2 realizes improvement in the low-temperature fixation suitability and the glossiness, in which the toner has the core-shell structure composed of the core containing crystalline and amorphous polyester resins and the shell containing amorphous polyester resin.

However, the toner disclosed in Patent Document 2 has a structure in which the colorant is dispersed in uniform by the influence of crystalline polyester domains and wax, domains formed in the toner particle. Namely, the hydrophobic colorant particles are easily crowded around the crystalline polyester domain and the wax domain so that the colorant particles are difficultly dispersed in uniform in the toner particle. Consequently, the covering power of the toner is lowered so that the consumption of the toner necessary for forming the image is raised. Moreover, the chromaticness is lowered and the reproducible color region is also insufficiently expanded.

On the other hand, although clearness of color is required, a problem that images of soft tone having lowered chromaticness (color slightly darkened by adding a slight amount of black to clear color for expressing calm and gentle atmosphere) and dull tone having lowered brightness (color slightly darkened by adding a slight amount of black to clear color for expressing calm and a little complex expression) are difficultly reproduced. Therefore, a toner set including a black toner capable of inhibiting chromaticness and brightness of color is required.

Furthermore, it is known that the crystalline polyester tends to cause filming on the parts contacting with the toner such as the photoreceptor; cf. Patent Document 3, for example. There is possibility that the toner particles containing the crystalline are crushed during the printing for prolonged period even when the particles have the core-shell structure such as that described in Patent Document 2. Accordingly, it is worried to cause the filming by the crystalline as to the toner disclosed in Patent Document 2.

Patent Document 1: JP A 2007-140478

Patent Document 2: JP A 2008-40319

Patent Document 3: JP A H05-45929

### SUMMARY OF THE INVENTION

An object of the invention is to provide a color toner improved in the low-temperature fixation suitability by which high image quality improved in the glossiness and expanded in the reproducible color region can be obtained and the curling is not caused at the fixation by heating even when the hydrophilic paper is used, and an image forming method using the toner. Another object of the invention is to provide a color toner and an image forming method using the color toner by which clear tone image can be obtained while inhibiting the toner consumption and the image formation and the image formation can be stably carried out for prolonged period while preventing the filming of the toner onto the toner-contacting parts even though the toner containing crystalline polyester resin. Further object of the invention is to provide an electrophotographic color toner and a color image forming method by which a “digital printing machine” alternative with the offset printing machine can be realized by solving the above problems.

### PREFERRED EMBODIMENT OF THE INVENTION

An embodiment of the invention is a combination of a yellow toner, a magenta toner, a cyan toner and a black toner.

Each of the color toners contains a colored particle containing an amorphous polyester resin, a crystalline polyester resin, a colorant and a releasing agent and a cerium oxide particle as an external additive, and the colorant of the yellow toner contains C.I. Pigment Yellow 74 as the colorant, the colorant of the magenta toner contains C.I. Pigment Red 122 and C.I. Pigment Red 238 as the colorant, the colorant of the cyan toner contains any one of C.I. Pigment Blue 15:1, C.I. Pigment Blue 15:2 and C.I. Pigment Blue 15:3 as the colorant, and the colorant of the black toner contains carbon black and any one of C.I. Pigment Blue 15:1, C.I. Pigment Blue 15:2 and C.I. Pigment Blue 15:3 as the colorant.

Another embodiment is a color image forming method using at least four kinds of toners of a yellow toner, a magenta toner, a cyan toner and a black toner, and each of the toners contains at least a binder resin containing an amorphous polyester resin, a colorant, a releasing agent, a crystalline polyester resin as a fixation assisting agent and an external additive containing a cerium oxide particle or a higher alcohol having 20 to 50 carbon atoms, and the yellow toner contains C.I. Pigment Yellow 74 as the colorant, the magenta toner contains C.I. Pigment Red 122 and C.I. Pigment Red 238 as the colorant, the cyan toner contains any one of C.I. Pigment Blue 15:1, C.I. Pigment Blue 15:2 and C.I. Pigment Blue 15:3 as the colorant, and the black toner contains carbon black and any one of C.I. Pigment Blue 15:1, C.I. Pigment Blue 15:2 and C.I. Pigment Blue 15:3 as the colorant.

At least one of the color toners to be used in the color image forming preferably has a core-shell structure. The core preferably contains the crystalline polyester resin and the amorphous polyester resin. It is preferable that each of color toners has a core-shell structure.

The color image forming method preferably has a cleaning process for removing the toner remaining on the photoreceptor by using a blade or a brush.

### BRIEF DESCRIPTION OF DRAWINGS

FIGS. 1 (a) through (c) show schematic view of cross sectional view of a colored particle according to the present invention.

FIG. 2 shows schematic view of an image forming apparatus to which the set of the color toners can be applied.

### DESCRIPTION OF THE INVENTION

By the invention, the fixing ability at low temperature is improved and full-color images having high glossiness can be obtained without causing the curling at the fixation by heating even when hydrophilic paper is used. Thus obtained full-color images have a wealthy of color tone with wide color region. Moreover, the toner consumption is inhibited and clear tone can be easily obtained and the toners do not indiscriminately adhere onto the parts of the apparatus in the invention.

The image forming method capable of realizing the “digital printing machine” can be provided by the invention, by which the usual offset printing machine can be replaced As mentioned above.

The invention relates to the color image forming method in which electrostatic latent images are developed by using at least four kinds of toner, namely the yellow toner, magenta toner, cyan toner and black toner.

The toners to be used in the invention each contain the amorphous polyester resin, crystalline polyester resin, colorant and releasing agent in the particle thereof.

The magenta colorant C.I. Pigment Red 122 and the black colorant each have high hydrophobicity and polarity near the crystalline polyester. Therefore, these colorants tend to be crowded around the crystalline polyester resin in the toner particle containing the crystalline polyester resin as the binder. Consequently, it is difficult to uniformly disperse these colorants in the binder resin by the influence of the crystalline polyester resin in the toner using the crystalline polyester resin as the binder. The inventors intend to realize the uniform dispersion of the colorant in the binder resin by using C.I. Pigment Red 122 and C.I. Pigment Red 238 in combination in the designing of the toner. As a result of that, the uniform dispersion of the colorant can be succeeded in the toner using these colorants so that the toner consumption at the image formation can be inhibited and the chromaticness of secondary color is raised so that the reproducible color region can be expanded.

As to the black toner, carbon black particles tend to be crowded around the crystalline polyester. Therefore, the uniform dispersion of colorant can be realized by using any one of C.I. Pigment Blues 15:1, 15:2 and 15:3. It is, presumed that C.I. Pigment Blues 15:1, 15:2 and 15:3 used together with the carbon black are function as a dispersion assisting agent for the carbon black at the same time as the colorant in the toner production process. By uniformly dispersing the carbon black in the toner particle, consumption of black toner is reduced and images having gradation reproducing property higher than that of the image obtained by the toner using the carbon black only. Toner images having solid look can be easily formed by the black toner to be used in the invention.

By the same reason, the cyan toner in which cyan colorant is uniformly dispersed can be obtained by using any one of C.I. Pigment Blues 15:1, 15:2 and 15:3 as the colorant for the cyan toner.

The inventors investigate yellow colorants capable of being uniformly dispersed in the toner particle containing the crystalline polyester resin. As a result of that, it is found that C.I. Pigment Yellow 74 can be uniformly dispersed in the binder resin. It is presumed that yellow images without influence of variation of yellowing degree can be obtained even when the amorphous polyester resin is yellowed according to passing of time.

Furthermore, it is made possible to prevent occurrence of filming by using toner particles to which cerium oxide particles are added as the external additive even when the image formation is continuously carried out for a long period. It is considered that such the effect is caused by selective accumulation of the cerium oxide particles at the toner scraping portion of the cleaning blade during the repeated image formation. Namely, it is presumed that the particles are accumulated in narrow spaces on the surface of the cleaning blade to fill the space in which the toner particles can enter so that the occurrence of filming is prevented. Reason of that such the particles are selectively accumulated in the narrow space on the surface of the cleaning blade is not cleared. The selective accumulation may be caused by the resistivity and the triboelectric series of the cerium oxide particle and the elastic parts constituting the cleaning blade. It is considered that the cerium oxide particles suitably polish the filmed material and keep the clearness of the surface so that the lowering in transferring ability and image quality caused by the accumulation of filmed material is inhibited. Besides, it is also presumed that the cerium oxide particle are fixed by suitable adhering force onto the surface of the shell layer formed by the amorphous polyester resin particles so that the transfer of the toner is carried out with high fidelity and the fine expression ability of the tone by addition of black is improved.

The invention is described in detail below.

The amount of colorant to be contained in each of the yellow toner, magenta toner, cyan toner and the black toner is described below.

The amount of the magenta colorant is preferably from 3 to 12% by weight of the magenta toner particles according to the hiding ratio, the transparency and the balance of color formation. The mixing ratio of the C.I. Pigment Red 122 and C.I. pigment Red 238 is preferably from 4:6 to 7:3, more preferably from 5:5 to 6:4 from the viewpoint of uniform dispersion of the colorant particles in the binder resin. The color within the dark blue region is improved by applying the above ratio.

The amount of the carbon black in the black toner is preferably from 1 to 8% by weight of the black toner particles and the amount of C.I. Pigment Blue 15:1, 15-2 or 15-3 for accelerating uniform dispersion the carbon black is preferably from 2 to 7% by weight of the toner. It is preferable to set the amount of the carbon black at 2 to 6% by weight of the toner and that of C.I. Pigment Blue 15:1, 15:2 or 15:3 at 3 to 6% by weight of the toner from the viewpoint of to obtain high gradation reproducing property and solid looks. The permittivity of the black toner is lowered and the transfer ratio is improved under the same conditions as the other color toners by applying the above ratio. Moreover, discrimination of the dull tone and the soft tone requiring the addition of black color is improved. When the black toner is used for adding black color, the solid looks of an image having lowered brightness, in which dots formed by the black toner and dots formed by the cyan toner are partially overlapped, tends to be raised compared with that of the image formed by a usual black toner.

The amount of the C.I. Pigment Yellow is preferably from 4 to 8% by weight of the yellow toner and the influence of the variation of yellowing may be dissolved even when the amorphous polyester resin is yellowed according to the passing of time. The chromaticness and color reproducibility of green color are improved by applying the above ratio. Among the toners containing the crystalline polyester resin, the yellow toner particularly tents to cause filming onto the immediate transfer belt. Such the problem can be solved by using C.I. Pigment Yellow 74.

The adding amount of the colorant selected from C.I. Pigment Blues 15:1, 15:2 or 15:3 is preferably from 4 to 9% by weight. The expression ability of low brightness image is raised in the region of bluish purple and green at the above adding amount. Expression ability of dark blue is raised and process black dots without any bias can be formed by overlapping with the yellow toner and the red toner.

The toners to be used in the invention each contain the toner particle containing the amorphous polyester resin, the above-described colorant, the wax and the crystalline polyester resin and are preferably ones having the core-shell structure for realizing the low-temperature fixing suitability. When the toner having the core-shell structure is prepared, it is preferable that the core contains at least the crystalline polyester resin, amorphous polyester resin, wax and colorant and the shell contains the amorphous polyester resin. It is presumed that fine gradation reproduction ability of the soft tone and the dull tone requiring addition of black color can be improved additionally to the improvement in green and dark blue colors by that the colorant particles are mixed between the color toner layers when the overlapping portion of the dots formed by each of the colors are melted when the colorants of the invention are used in each of the toners containing the crystalline polyester resin, amorphous polyester resin and wax.

The toners comprise an amorphous polyester resin, a colorant, a releasing agent and a crystalline polyester resin. The toners preferably have a core shell constitution in view of good low temperature fixing performance. In such instance it is preferable that the core shell toner particle is composed of a core comprising an amorphous polyester resin, a colorant, a releasing agent and a crystalline polyester resin and a shell comprising an amorphous polyester resin.

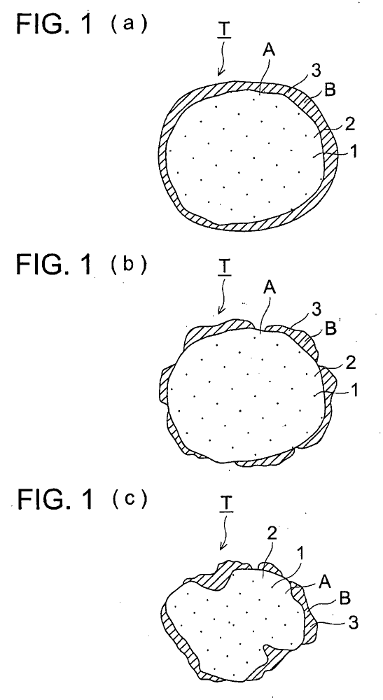

An example of a core shell toner is shown in FIG. 1(a) (b) and (c). The toner particle T is composed of core A comprising resin 2 containing colorant 1 and shell B comprising resin 3 covering the core. In the figures a crystalline polyester resin and an amorphous resin forming domain in the core are not shown in toner T.

Toner T shown in FIG. 1(a) has shell B covering the whole surface of core A. Toners of this invention may have structure in which shell B does not cover whole surface of core A and core A is partly exposed as shown in FIG. 1(b). Shell B covers 30 to 100%, preferably 50 to 95% of the surface of core A in FIG. 1(b). Core of toner shown in FIG. 1(c) has concaves on the surface. These toner particles may also be employed in the present invention.

Cross section structure or coverage of shell on the core can be confirmed by observation employing a transmission electron microscope (TEM) or a scanning probe electron microscope (SPM). TEM can be employed for evaluation of hardness of a resin composing the toner in addition to observing cross section shape.

The observing method by TEM is described. Toner particles can be measured by observing an image photographed through a transmission electron microscope.

For example, the first step of the method is to prepare a toner sample for observation. Test sample were prepared by dispersing toner particles sufficiently in room-temperature-setting epoxy resin, embedding toner particles in styrene resin particles having a particle diameter of about 100 nm, pressure molding the mixture into a block, dyeing the block together with ruthenium tetraoxide or osmium tetraoxide, and slicing the block into a segment of 80 to 200 nm thick by a microtome with diamond teeth.

The sliced samples are photographed by a TEM to observe a cross sectional structure of the toner particles. Magnification power of the TEM is set so that a sectional view of one toner is included in a frame, for example, around 10,000. Number of the photograph to be observed is preferably 10 ore more.

The structure of toner particles is well-observed through a TEM which is well known to those skilled in the art such as LEM-2000 (by Topcon Corporation) and JEM-200FX (JOEL Ltd.).

The toner is confirmed to have core shell structure by observing a cross section photograph in which a region containing a colorant and another region containing no colorant are observed, and boundary between the core and shell is observed.

Coverage of shell on the surface of the core can be measured by arithmetic processing of the image information obtained by TEM photo by an image processing apparatus LUZEX. F (by Nireco Corporation). Area of core region and shell region is measured by arithmetic processing of the photo, and an average coverage is calculated for 10 or more samples.

A crystalline polyester resin and an amorphous polyester resin employed in the toner of this invention are described.

(1) Crystalline Polyester Resin

The toners according to this invention comprise a crystalline polyester resin. The crystalline polyester resin improves low temperature fixing property and is considered to work as a fixing aid. It is preferable that the crystalline polyester resin is incorporated in core region when the toner has core shell construction. The crystalline polyester resin means those show a clear endothermic peak but not gradual endotherm characteristics by differential scanning calorimetry (DCS). The crystalline polyester resin according to this invention includes the resin having crystalline back bone chain to which other component is copolymerized, as far as the resin shows an endotherm peak by DSC.

Various dicarboxylic acid components may be employed to compose the crystalline polyester resin. Preferable examples are an aliphatic dicarboxylic acid and an aromatic dicarboxylic acid, and a straight chain aliphatic dicarboxylic acid is particularly preferable. The dicarboxylic acid is not restricted to one species and may be composed of two or more dicarboxylic acids as the acid component. The dicarboxylic acid may contain a sulfonic acid group in view of obtaining good emulsification characteristics when the polyester resin is formed by an emulsion polymerization.

An example of the dicarboxylic acid component forming the crystalline polyester resin includes oxalic acid, malonic acid, succinic acid, glutaric acid, adipic acid, pimelic acid, suberic acid, azelaic acid, sebacic acid, 1,9-nonane dicarboxylic acid, 1,10-decane dicarboxylic acid, 1,11-undecane dicarboxylic acid, 1,12-dodecane dicarboxylic acid, 1,13-tridecane dicarboxylic acid, 1,14-tetradecane dicarboxylic acid, 1,16-hexaecane dicarboxylic acid and 1,18-octadecane dicarboxylic acid. Lower alkyl esters or anhydride acids of these dicarboxylic acids may be employed, citraconic acid, maleic acid, fumaric acid, itaconic acid, glutaconic acid, isododecyl succinic acid, isododecenyl succinic acid, n-dodecyl succinic acid, n-dodecenyl succinic acid, n-octyl succinic acid, or n-octenyl succinic acid; and acid anhydrides thereof or acid chlorides thereof. Further, in addition to these aliphatic dicarboxylic acids, there are exemplified aromatic dicarboxylic acids such as phthalic acid, isophthalic acid, terephthalic acid, or naphthalene dicarboxylic acid. Adipic acid, sebacic acid and 1,10-decane dicarboxylic acid are preferably in view of easy availability among them.

An aromatic dicarboxylic acid may be added to the aliphatic dicarboxylic acid to prepare the crystalline polyester resin. An example of the applicable aromatic dicarboxylic acid includes terephthalic acid, isophthalic acid, o-phthalic acid, t-butylisophthalic acid, 2,6-naphthalenedicarboxylic acid, 4,4′-biphenyldicarbokylic acid. Terephthalic acid, isophthalic acid, and t-butylisophthalic acid are preferably in view of easy availability among them. Amount of the aromatic dicarboxylic acid is preferably 20 component mol % or less, preferably 10 mol % or less and more preferably 5 mol % or less. It is preferred because emulsification is surely processed during polymerization as well as good crystallinity of polyester resin can be maintained by employing above mentioned amount of aromatic dicarbokylic acid, whereby image glossy specific to the crystalline polyester resin can be obtained. Further degradation of image storage stability due to depression of melting point is minimized.

An alcohol compound as alcohol component of the crystalline polyester resin is preferably an aliphatic diol, and more preferably a straight chain aliphatic diol having 2 to 22 carbon atoms composing its back bone chain. A straight chain aliphatic diol having 2 to 14 carbon atoms composing its back bone chain is more preferable in view of easy availability, good low temperature fixing performance and high glossy image. A branched type aliphatic diol may be employed, whose content is preferably less than that of straight chain aliphatic diol, in view of that good crystallinity of the polyester resin is obtained, in addition thereto, degradation of image storage stability due to depression of melting point is minimized and is effective for minimizing toner blocking and stabilizing low temperature fixing performance.

Polyester resin having low melting point is not prepared by employing an aliphatic diol having 2 to 22 carbon atoms in the back bone chain, and the obtained polyester resin is molten sufficiently by low temperature fixing, when an aromatic dicarboxylic acid is used together. An image having high glossiness is also formed.

An example of the aliphatic diol to form the crystalline polyester includes ethylene glycol; 1,3-propanediol, 1,4-butanediol, 1,5-pentane glycol, 1,6-hexane glycol, 1,7-heptane glycol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol and 1,20-eicosanediol. It is preferable to employ ethylene glycol, 1,4-butanediol, 1,6-hexane glycol, 1,9-nonanediol and 1,10-decanediol.

Diol components other than the aliphatic diol may be incorporated in the alcohol component. The aliphatic diol is preferably used 80 component mol % or more, more preferably 90 mol % or more among the alcohol component to compose the crystalline polyester resin. It is effective to use 80 component mol % of aliphatic diol because of good crystallinity of polyester resin, high glossiness of toner image and good low temperature fixing performance.

An example of the alcohol component in addition to the aliphatic diol includes a diol component having a double bond and a diol component having sulfonic acid group. An example of the diol component having a double bond includes 2-butene-1,4-diol, 3-butene-1,6-diol, 4-butene-1,8-diol. Content of the diol component having a double bond is preferably 20 component mol %, more preferably 2 to 10 mol % of the whole amount of the alcohol component. Crystallinity of the obtained polyester resin would not be affected and meting point of the polyester resin would not so much lowered, and therefore, occurrence of filming is minimized when the content is set as less than 20 component mol %.

The crystalline polyester resin preferably has a melting point of 60 to 98° C., more preferably 70 to 92° C. The problems such as occurrence of filming, degradation of image store stability due to melting point of the polyester, and coarse image or degradation of glossiness due to high melting point are minimized.

The crystalline polyester resin preferably has a molecular weight of 3,000 to 20,000, more preferably 11,000 to 19,000, in view of inhibiting filming.

Content of the crystalline polyester resin in the whole colored particle is preferably 1 to 40% by weight, and more preferably 5 to 30% by weight. Expected low temperature fixing performance can be obtained and dispersion property of colorant is not inhibited when the content is 1 to 40% by weight.

(2) Amorphous Polyester Resin

The toner of this invention comprises an amorphous polyester, whereby good dispersion performance of colorant is realized and anti-filming characteristics of the toner are improved.

The amorphous polyester resin according to the invention means a polyester resin which does not exhibit endotherm peak in the DSC endothermic change.

The amorphous polyester resin is formed by synthesizing polycarboxylic acid and polyol. Amorphous polyester resin is available from market, and can be synthesized according to necessity. The core region may be composed of a single kind of the first amorphous polyester resin or two or more kinds may be used in combination. The second amorphous polyester resin used in shell region may be same kind of the first amorphous polyester resin used in core region or different.

A glass transition temperature of the amorphous polyester resin is 51.1 to 65.0° C.

The amorphous polyester resin used for the shell region is preferably the same kind of amorphous polyester resin used for the core region when the toner is composed of core and shell.

An example of polyol to form the amorphous polyester includes diol such as ethylene glycol, propylene glycol, 1,4-butanediol, 2,3-propanediol, diethylene glycol, triethylene glycol, 1,5-pentane glycol, 1,6-hexane glycol, neopentylene glycol, 1,4-cyclohexane dimethanol, dipropylene glycol, polyethylene glycol, polypropylene glycol, bisphenol A and hydrogenated bisphenol A, and tree or more valent alcohol such as glycerin, sorbitol, 1,4-sorbitane and trimethylolpropane.

An example of the dicarboxylic acid component forming the amorphous polyester resin includes an aliphatic dicarboxylic acid and an aromatic dicarboxylic acid. An example of the aliphatic dicarboxylic acid includes oxalic acid, succinic acid, glutaric acid, adipic acid, suberic acid, azelaic acid, sebacic acid, 1,9-nonane dicarboxylic acid, 1,10-decane dicarboxylic acid, 1,12-dodecane dicarboxylic acid, 1,14-tetradecane dicarboxylic acid, and 1,18-octadecane dicarboxylic acid. An example of the aromatic dicarboxylic acid includes phthalic acid, isophthalic acid, terephthalic acid, or naphthalene-2,6-dicarboxylic acid, malonic acid and mesaconic acid. A salt of dibasic acid or acid anhydride of these may also employed.

Three or more valent carboxylic acid may be employed. An example thereof includes 1,2,4-benzenetricarboxylic acid, 1,2,5-benzenetricarboxylic acid and 1,2,4-naphthalenetricarboxylic acid. Anhydride acids or Lower alkyl esters of these dicarboxylic acids may be employed. These may be used singly or two or more in combination.

It is preferable that the dicarboxylic acid component composing the amorphous polyester resin contains a dicarboxylic acid component having a sulfonic acid group in addition to the above described aliphatic dicarboxylic acid or aromatic dicarboxylic acid. The dicarboxylic acid having a sulfonic acid group is advantageous because it contributes to improve dispersion performance. Resin particles can be dispersed as an emulsion or suspension in an aqueous medium to form resin particle dispersion without employing a surfactant when the dicarboxylic acid component contains sulfonic acid group.

The amorphous polyester resin preferably has a molecular weight of 3,000 to 22,000, more preferably 10,000 to 20,000.

Content ratio of the crystalline polyester to the amorphous polyester in the toner (molar ratio, crystalline polyester:amorphous polyester) is preferably about 2:98 to 60:40, and more preferably 5:95 to 50:50, in view of obtaining good fixing performance.

Preparation method of polyester resin is described. The polyester resin can be prepared by a polyester polymerization method reacting acid component with alcohol component. Practically the method can be selected from, for example, direct condensation polymerization and ester exchange method, according to kinds of monomers. Molar ratio of the acid component to alcohol component in the reaction varies according to reaction condition or so, and is not specified in general, but usually 1:1.

Polymerization temperature is preferably 180 to 230° C. in the preparations of polyester resin. It is also preferable to reduce the inner pressure of the reaction system, if necessary. It is also preferable that water or alcohol generated by the reaction is moved from the reaction system during the reaction. Solvent having high boiling point may be added as solvent aid to dissolve a monomer which is not soluble or compatible at reaction temperature. It is preferable to remove solvent aid by distillation during reaction process. It is also preferable that a monomer having poor compatibility is subjected to polymerizing reaction with majority component after the monomer having poor compatibility is preliminary reacted with an acid or alcohol to be reacted.

It is preferable to employ a catalyser to conduct polymerization reaction in preparation process of the polyester resin. An example of the catalyser includes a tin compound, zirconium compound and germanium compound, listed as; tetraphenyltin, dibutyltin chloride, dibutyltin oxide, diphenyltin oxide, zirconium tetrabutoxide, zirconium naphthenate, zirconyl carbonate, zirconyl acetate, zirconyl stearate, zirconyl octylate, germanium oxide, triphenyl phosphite, tris(2,4-di-t-butylphenyl)phosphite, ethyltriphenylphosphonium bromide, triethylamine and triphenylamine. Rare earth metals, or Luis acid such as dodecylbenzenesulfonic acid may be employed from a view point of reducing discharge amount of carbonate gas generated during the reaction by lowering polymerization temperature.

Toner of this invention contains a releasing agent. Listed as specific examples of release agents used herein may be low molecular weight polyolefins such as polyethylene, polypropylene or polybutene; synthesis ester wax, plant based wax such as carnauba wax, rice wax, candelilla wax, japan tallow and jojoba oil; mineral petroleum based wax such as montan wax, paraffin wax, microcrystalline wax and Fischer-Tropsch wax; and denatured material of these.

It is preferable to employ a synthesis wax having a melting point of 70 to 95° C. among the above described waxes in view of inhibiting filming. An example thereof includes behenyl behenate, pentaerythritol behenate and tribehenyl citrate. Improvement of glossiness of the toner image and improvement of filming can be attained compatibly when paraffin wax having a melting point of 70 to 100° C. is employed with the synthesis wax such as behenyl behenate, pentaerythritol behenate and tribehenyl citrate.

Offset property at high temperature can be improved at any processing speed from low to high speed by employing Fischer-Tropsch wax having a melting point of 75 to 100° C. among the paraffin waxes, and further good cleaning performance can be displayed using cleaning device having cleaning blade.

Content of the releasing agent in the toner is preferably 5 to 20% by weight and more preferably 7 to 13% by weight, in view of minimizing offset or filming generation as the releasing agent is kept stably within a toner particle.

Preparation method of toners of this invention is described.

Emulsion aggregation method is preferable as a preparation method of toners of this invention. The emulsion aggregation method is preferable since shape distribution of toner particles can be controlled during the preparation process, toners having good storage stability and cleaning property may be prepared with high efficiency, and environmental load can be suppressed in comparison with other preparation method. The aggregation method to prepare toners is described.

The aggregation method to prepare toners comprises, for example, the following steps.

### (1) Aggregation Process

Aggregated particles are formed in this process, wherein aggregation agent is added to mixed dispersion liquid obtained by mixing an amorphous polyester resin particles dispersion, a colorant dispersion, a releasing agent dispersion and a crystalline polyester resin particles dispersion, and the mixture is heated. The amorphous polyester resin particles dispersion contains amorphous polyester resin particles preferably having volume based median particle diameter of 1 μm or less.

### (2) Fusion Process

Amorphous polyester resin in the aggregated particles is fused by heating up to temperature than glass transition temperature of the amorphous polyester resin in this process.

### (3) Cooling Process

Reinforced aggregated particles by fusion process are cooled rapidly, for example, with cooling speed of −20° C./minute or more in this process.

### (4) Washing and Drying Process

Cooled aggregation particles are subjected to solid/liquid separation by for example, filtration, and are washed then dried.

### (5) External Additive Addition of Process

External additives such as cerium oxide particles are added to the dried aggregation particles.

Adhesion process is included to prepare toner having core shell structure. Amorphous polyester resin particles are added to the aggregated particles, which will compose core region, to adhere the amorphous polyester resin particles on a surface of the aggregated particles. This process may be conducted after the aggregation process, and resin particles adhered particles are subjected to the fusion process and cooling process to prepare the core shell toner.

Core shell toner can be obtained easily by the above mentioned procedure. Thus obtained core shell toner has advantage of improving anti-filming property since exposure of components composing core such as a releasing agent, a colorant and crystalline polyester particles is inhibited by covering with shell.

Each process is detailed.

### 1. Aggregation Process

1-1. Preparation of each Dispersion

Mixed dispersion liquid is prepared by mixing dispersions employed in the aggregation process at first. The dispersions include an amorphous polyester resin particles dispersion containing amorphous polyester resin particles, a colorant dispersion containing a colorant, a releasing agent dispersion containing a releasing agent and a crystalline polyester resin particles dispersion containing crystalline polyester resin particles. Other dispersions than these dispersions such as charge control agent dispersion may be mixed if necessary.

Content of total amount of amorphous polyester resin particles and crystalline polyester resin based on the total solid component in the mixed dispersion liquid is preferably 40% by weight or less, and more preferably 2 to 20% by weight. Content of a colorant based on the total solid component in the mixed dispersion liquid is preferably 20% by weight or less, and more preferably 2 to 15% by weight. Content of a releasing agent based on the total solid component in the mixed dispersion liquid is preferably 20% by weight or less, and more preferably 5 to 15% by weight.

Content of the other component particles, when it is employed, is selected so that compatibility of low temperature fixing performance with storage stability is not deteriorated. Generally, the content is limited to small amount, and is preferably 0.01 to 5% by weight, more preferably 0.5 to 2% by weight based on the total solid component in the mixed dispersion liquid, practically.

Dispersion method can be selected suitably. Example of the dispersion apparatus available for dispersion includes HOMOMIXER (by Tokushu Kikakogyo Co., Ltd.), SLASHER, (by Mitsui Mining Co., Ltd.), CAVITRON (by Eurotech Co., Ltd.), MICROFLUIDIZER (by Mizuho Industrial Co., LTD.), MANTON GAURIN HOMOGENIZER (by Gaurin Co.), NANOMIZER (by Nanomizer Inc.) and STTIC MIXER (by Noritake Co., Ltd.). A solvent emulsification method or a phase transition emulsification method can be employed for dispersing resin particles.

Preparation method of each dispersion is described.

### (1) Preparation Method of a Resin Particles Dispersion

Amorphous polyester resin particles dispersion and crystalline polyester resin particles dispersion are prepared by the following way. Resin is dispersed in aqueous medium with an ionic surfactant, a polymer electrolyte such as polymer acid or polymer alkali. Then the dispersion is heated at temperature higher than melting point or glass transition temperature of the amorphous polyester resin or crystalline polyester resin and is processed while giving strong shearing force by employing a homogenizer or a pressure discharge type dispersion machine to obtain resin particles dispersion. Dispersion can be prepared by dissolving the resin in a solvent, dispersing in an aqueous medium by employing homogenizer and desalting. Dispersion can also be prepared by phase reversal dispersion in which the resin is dissolved in a solvent, resulting solution is neutralized and is subjected to phase reversion by adding water while stirring, then is subjected to desalting.

Volume average particle diameter of the amorphous polyester resin particles or crystalline polyester resin particles is preferably 1 μm or less and more preferably 0.02 to 0.5 μm, since final product toner particles having sharp particle size distribution and sharp shape factor distribution without free particles are obtained. The polyester resin particles are dispersed un good state and components in the toner particles are not localized, and it is advantageous since variation of performance and reliability is minimized The volume average particle diameter of the resin particles are measured by employing, for example, MICROTRACK (by Nikkiso Co., Ltd.)

### (2) Preparation of Colorant Dispersion

Various dispersion methods are employed for the preparation of colorant dispersion. Practical examples of the dispersion means include a rotary shearing type homogenizer, a dispersion apparatus having medium such as ball mill, sand mill, DYNO-MILL, ULTIMAIZER. The colorant is dispersed in water together with an ionic surfactant, a polymer electrolyte such as polymer acid or polymer alkali. Volume average particle diameter of the colorant subjected to dispersion process is preferably 1 μm or less and more preferably 80 to 500 nm. Good aggregation performance and dispersion stability of the colorant in the toner particles are obtained.

### (3) Preparation of Releasing Agent Dispersion

Releasing agent is dispersed in aqueous medium with an ionic surfactant, a polymer electrolyte such as polymer acid or polymer alkali. Then the dispersion is heated at temperature higher than melting point of the releasing agent and is processed while giving strong shearing force by employing a homogenizer or a pressure discharge type dispersion machine to obtain resin particles dispersion. Thus releasing agent dispersion containing the releasing agent particles having volume average particle diameter of, preferably, 50 nm to 1 μm is obtained. More preferably the volume average particle diameter is 100 to 500 nm. The releasing agent is effectively incorporated in the toner particles and stable dispersion state of the releasing agent in the toner particle is obtained. The releasing agent dispersion can be mixed at once together with other dispersions such as resin particles dispersion, or at several times separately.

Aggregation agents, a dispersion media and surfactants employed in the preparation of toner by emulsion aggregation method are described.

### (1) Aggregation Agent

The aggregation agent includes a surfactant having reverse polarity to that of surfactants used as dispersion aid of the dispersion liquid, inorganic metal salt described above and a two or more valent metal complex. It is particularly preferable for improving charging ability of the toner to use the metal complex since amount of surfactant is reduced.

Examples of the inorganic metal salts include a metal salt such as calcium chloride, calcium nitrate, barium chloride, magnesium chloride, zinc chloride, aluminum chloride and aluminum sulfate, an inorganic metal salt polymer such as aluminum polychloride, aluminum polyhydroxide and calcium polysulfide. An aluminum salt and its polymer are preferable among them. The higher valent of the inorganic metal salt is employed, the sharper particle diameter distribution of the toner is obtained. Divalent is better than monovalent, trivalent is better than divalent, tetravalent is better than trivalent. Inorganic metal salt polymer is preferable for the same valent inorganic metal salt.

Amount of aggregation agent to be added depends on ion concentration at aggregation process, and is preferably 0.05 to 1.0 W by weight, more preferably 0.01 to 0.5% by weight of the solid based of mixed dispersion in general to form toner particles stably having particle diameter for suitably employed for forming high quality image.

### (2) Dispersion Medium

An aqueous medium includes a representative dispersion medium in the preparation of dispersion liquid. The “aqueous medium” means a medium containing water in a content of al least 50% by weight. A water-soluble organic solvent includes methanol, ethanol, iso-propanol, butanol, acetone, methyl ethyl ketone and tetrahydrofuran. Among them, an alcohol type organic solvent capable of not dissolving the resin is preferably used. Distillation water or ion exchanged water is used.

### (3) Surfactant

Dispersion liquid preferably contains a surfactant. Listed as surfactants are, for example, an anionic surfactant such as those which are sulfuric acid ester salt based, sulfonic acid salt based, phosphoric acid ester based, and soap based; a cationic surfactant such as an amine salt type and a quaternary ammonium salt type; and a nonionic surfactant such as polyethylene glycol based, alkylphenol ethylene oxide addition product based, and polyhydric alcohol based. Of these, preferred is an ionic surfactants and more preferred is an anionic and a cationic surfactant. Surfactants may be employed individually or in combinations of at least two types.

Specific example of anionic surfactants includes fatty acid soaps such as potassium laurate, sodium oleate and sodium salt of castor oil; sulfuric acid ester compound such as octyl sulfate, lauryl sulfate, lauryl ether sulfate and nonyl phenyl ether sulfate; sodium alkylnaphthalene sulfonates such as lauryl sulfonate, dodecylsulfonate, dodecylbenzenesulfonate, triisopropylnaphthalene sulfonate and dibutylnaphthalene sulfonate; sulfonic acid salt compound such as naphthalenesulfonate formalin condensation product, monooctylsulfosuccinate, dioctylsulfosuccinate, lauric acid amidosulfonate and oleic acid amidosulfonate; phosphoric acid esters such as lauryl phosphate, isopropyl phosphate and nonyl phenyl ether phosphate; and sulfosuccinic acid salts such as dialkylsulfosuccinic acid salts such as sodium dioctylsulfosuccinate, disodium lauryl sulfosuccinate and disodium polyoxyethylene lauryl sulfosuccinate.

Specific example of the cationic surfactant include an amine salt compound such as a lauryl amine hydrochloric acid salt, stearyl amine hydrochloric acid salts, oleyl amine acetic acid salts, stearyl amine acetic acid salts and stearyl aminopropyl amine acetic acid salts; and a quaternary ammonium salt compound such as lauryltrimethylammonium chloride, dilauryldimethyl ammonium chloride, distearylammonium chloride, distearyldimethyl ammonium chloride, lauryldihydroxyethyl ammonium chloride, oleylbispolyoxyethylene methylammonium chloride, lauroylaminopropyldimethylethyl ammonium ethosulfate, lauroylaminopropyldimethylhydroxyethyl ammonium perchlorate, alkylbenzenedimethyl ammonium chloride and alkyltrimethylammonium chloride.

Specific example of the nonionic surfactant includes an alkyl ether compound such as polyoxyethylene octyl ether, polyoxyethylene lauryl ether, polyoxyethylene stearyl ether and polyoxyethylene oleyl ether; an alkylphenyl ether compound such as polyoxyethylene octyl phenyl ether and polyoxyethylene nonyl phenyl ether; an alkyl ester compound such as polyoxyethylene laurate, polyoxyethylene stearate and polyoxyethylene oleate; an alkylamine compound such as polyoxyethylene lauryl aminoether, polyoxyethylene stearyl aminoether, polyoxyethylene oleyl aminoether, polyoxyethylene soy bean aminoether and polyoxyethylene tallow aminoether; an alkylamide compound such as polyoxyethylene lauric acid amide, polyoxyethylene stearic acid amide and polyoxyethylene oleic acid amide; a vegetable oil ether compound such as polyoxyethylene castor oil ether and polyoxyethylene rapeseed oil ether; an alkanolamide compound such as lauric acid diethanolamide, stearic acid diethanolamide and oleic acid diethanolamide; a sorbitan ester ether compound such as polyoxyethylenesorbitan monolaurate, polyoxyethylene sorbitan monopalmitate, polyoxyethylene sorbitan monostearate, or polyoxyethylene sorbitan monooleate.

### 1-2. Aggregation Process

Aggregated particles aggregated particles are formed by mixing the various dispersion liquid described above after the preparation of the dispersion liquid. Aggregation agent is added to a mixed dispersion liquid obtained by mixing amorphous polyester resin dispersion, colorant dispersion, releasing agent dispersion, crystalline polyester resin dispersion and other dispersion. The mixture is heated up to around glass transition temperature of the amorphous polyester resin after addition of the aggregation agent whereby each component is aggregated to form aggregated particles.

Aggregated particles forming process is conducted by adding the aggregation agent at room temperature during the mixture is stirred by a rotary shearing type homogenizer. The aggregation agent includes a surfactant having reverse polarity to that of surfactants used as dispersion aid of the dispersion liquid, inorganic metal salt described above and a two or more valent metal complex. It is particularly preferable for improving charging ability of the toner to use the metal complex since amount of surfactant is reduced.

### 1-3. Adhesion Process

Adhesion process is conducted to form toners having core shell structure. Resin particles comprising the amorphous polyester resin are adhered to a surface of aggregated particles (core) formed in the aggregation process to form a covering layer (shell). The aggregated particles having covering layer formed by adhering the resin particles on their surface are called resin particles adhered aggregated particles. The resin particles adhered aggregated particles correspond to shell of core shell structure, which is formed by a fusion process.

The covering layer is formed by adding resin particles dispersion containing amorphous polyester resin into dispersion in which aggregated particles are formed in the aggregation process, and other component such as aggregation agent may be added, if necessary. Amorphous polyester resin particles used for forming coverage layer may be the same as or different from that is used for the aggregated particles (core) The amorphous polyester resin particles having same or higher glass transition point by 0 to 20° C. than that of the aggregated particles resin is preferably used for the coverage layer for improving storage stability against heat, when different amorphous polyester resin particles from the aggregated particles are used.

Resin particles in the coverage layer is fused to form a shell by thermal fusion of the resin particles adhered aggregated particles obtained by adhering resin particles on the aggregated particles, and core shell particles are formed. The core comprising crystalline polyester, colorant releasing agent, and amorphous polyester having lower glass transition point than that of the amorphous polyester in the shell are covered by shell, and the core components are inhibited to be exposed to the toner surface effectively.

Addition of amorphous polyester resin amorphous polyester resin particles dispersion may be conducted continuously little by little, or several times separately in stepwise. The adhering process can be conducted once or more times. A plurality of shell layers can be formed by employing plural resins different each other.

The amorphous polyester resin particles are adhered to the surface of the aggregated particles in the following condition. Heating temperature during the adhering process is preferably from around glass transition temperature of the amorphous polyester resin in the aggregated particles to around glass transition temperature of the amorphous polyester resin forming the shell. The lower limit of the heating temperature is preferably Tg minus 5° C. to Tg plus 10° C., wherein Tg is glass transition temperature of the amorphous polyester resin in the aggregated particles in general. The upper limit of the heating temperature is preferably Tg′ minus 10° C. to Tg′ plus 10° C., wherein Tg′ is glass transition temperature of the shell forming amorphous polyester resin in general.

Glass transition temperature of the amorphous polyester resin used for the core of a core shell toner is preferably 51.1 to 65.0° C., and that of the amorphous polyester resin for the shell is also preferably 51.1 to 65.0° C. practically.

An example of the temperature setting in the adhesion process is that heating temperature in the adhesion process is preferably 47.0° C. to 62.0° C., when transition temperature of the amorphous polyester resin is 52.0° C. The upper limit temperature is preferably 68° C.

When the above mentioned temperature is employed amorphous polyester resin particles at the surface of the aggregated particles are properly fused with the adhered amorphous polyester resin particles and form uniform thickness of shell.

Generation of free amorphous polyester resin particles is minimized and harmful affect by the free resin particles, such as, filtration clogging in the washing/drying process and carrier stain due to fine particles remained as impurity, is minimized. Inadequate filming o an intermediate transfer member or photoreceptor is inhibited and transfer efficiency and image quality are improved due to the shell or cerium oxide particles are exhibited remarkably.

Excess fusion, for example, between resin particles adhered aggregated particles themselves is inhibited and uniform particle size and particle size distribution are obtained, and minimize the generation of image defect such as micro white spots.

Heating time is 5 minutes to two hours in general depending on heating temperature. Dispersion liquid may be allowed to still standing or subjected to moderately stirred by a mixer or so, after addition of resin particle dispersion for forming shell to mixed dispersion formed aggregated particles. The latter is preferable since uniform resin particles adhered aggregated particles can be obtained.

Amount of amorphous polyester resin particle dispersion depends on particle diameter of the resin particles in the dispersion, and is preferably selected so that the shell has thickness of 20 to 500 nm. The amount is preferably 1 to 40%, more preferably 5 to 30% by weight in solid converted weight based on total weight of toner. Good storage stability and low temperature fixing performance are realized certainly by making the shell thickness of 20 to 500 nm.

### 1-4. Aggregation Terminate Process

Aggregation is terminated by adding a sequestering agent after the aggregation process or adhesion process incase of forming core shell structure toner. The process is called aggregation termination process. Minute roughness on the surface of the toner is made smooth ultimately by controlling ion cross linking due to aggregation agent. Toner particles having an average circularity of 0.970 or more can be obtained.

FPIA-2100, manufactured by Sysmex Corp., was used for measurement of the average circularity of the toner particles. In this apparatus, the toner particles dispersed in water were subjected to measurement by a flowing image analysis method, and the suspension of the particles sampled by sucking up was introduced into a flat sheath flow cell and flat flow of the samples was formed by a sheath liquid. The flowing particles were photographed by a CCD camera in a form of still image by irradiating the flow of sample by strobe light.

The circularity of each of the particles was calculated by the following expression. The circularities of at least 5,000 particles were subjected to statistical treatment to calculate the average circularity.

Circularity=(circumferential length determined from equivalent circle diameter)/(circumferential length of projected image of particle)

HPF (high resolution) mode was applied and the dilution ratio was 1.0 at the measurement. At the data analysis, analysis range of particle number-particle diameter was set at from 2.0 to 31.1 μm and the analysis range of circularity was set at from 0.40 to 1.00 for removing noises of measurement.

Examples of the sequestering agent to terminate the aggregation include ethylenediamine tetraacetic acid (EDTA) and its alkali metal acid such as sodium salt, gluconal, sodium gluconate, potassium citrate, sodium citrate, salt of nitrotriacetate (NTA), GLDA (L-glutamic acid N,N-2-acetic acid, in market), humic acid, fulvic acid, maltol, ethyl maltol, pentaacetic acid, tetraacetic acid and water soluble polymer having functional group of both —COOH and —OH (polymer electrolyte). An alkali metal salt such as EDTA and its sodium salt are employed particularly preferably among them.

The sequestering agent is employed in an amount of about 0.01 to 5.0% by weight, preferably 0.1 to 4.0% by weight based on the total weight of the toner, depending on the applied material. Excess amount may cause disadvantage such that adhered shell releases.

Aggregation is terminated by employing the sequestering agent singly, and aqueous alkali such as sodium hydroxide and potassium hydroxide may be used in addition to the sequestering agent.

### 2. Fusion Process

The aggregated particles, and the resin particles adhered aggregated particles in case of preparing core shell toner, formed in the aggregation process are subjected to thermal process to be fused in the fusion process. The fusion process is conducted at a temperature higher than the glass transition temperature of the amorphous polyester resin. Time for fusion process depends on the temperature, and is generally from 20 minutes to 20 hours. The lower the processing temperature is the longer the processing time is required.

Cross linking reaction may be conducted in addition to the heating simultaneously in the fusion process. Cross linking reaction may be conducted after the completion of fusion process.

### 3. Cooling Process

The aggregated particles, and the resin particles adhered aggregated particles subjected to fusion process are cooled in the cooling process. The particles subjected to fusion process are preferably cooled rapidly to not higher than the recrystallization temperature of the amorphous polyester and releasing agent, and the glass transition temperature of the crystalline polyester. Cooling speed varies depending on the species and content of crystalline polyester in the core region, and it is preferably −20° C./minute or more rapidly, and more preferably −25° C./minute or more rapidly. Such rapid cooling inhibits or minimizes recrystallization and domain growth of the crystalline polyester and/or releasing agent in the core, and therefore, particles having smooth surface with least roughness is obtained. Consequently toner particles having an average circularity of 0.970 or more, median of arithmetical mean of height dispersion of 0.005 to 0.05 μm can be obtained. When the cooling is slower recrystallization is commenced and toner having rough surface WITH a component of the core exposed to the surface is likely to obtain. The toner having such rough surface may affect fluidity or charging performance.

Rapid cooling is conducted, for example, by passing the prepared toner slurry through a heat exchanger employing cooling water or brine, or pouring the prepared toner slurry into cooling water of 2 to 3 times volume of the slurry to make dilution.

### 4. Washing and Drying Process

Particles subjected to the fusion process and cooling process is subjected to washing and drying process after solid is separated from liquid by, for example, filtration. Colored particles, toner particles to which external additives are not added, are obtained by these processes. Sufficient washing is preferable to endow sufficient charging characteristics and reliability. Remarkable washing efficiency can be obtained by treating with acid such as nitric acid, sulfuric acid and hydrochloric acid or alkali such as sodium hydroxide and then washing with ion exchange water in the washing process. Usually applicable drying methods are employed in the drying process, whose examples include vibration fluidize drying method, spray drying method, freeze drying method and flash-jet drying method. Toner particles are preferably dried up to moisture content of 2% by weight or less, more preferably 1% by weight or less.

### 5. External Additive Addition of Process

External additives are added to dried colored particles, examples of the additives including cerium oxide, higher alcohol having 20-50 carbon atoms. Particle size of cerium oxide particles is preferably number average particle diameter of 150 to 800 nm, more preferably 250 to 700 nm to ensure cleaning property. Cerium oxide particles are added preferably in an amount of 0.5 to 3.5% by weight based on total weight of toner, whereby good cleaning property is maintained, anti-filming performance is stably exhibited and no drawback such as degradation of fixing strength due to inhibited adhesion strength of fused toner particles at thermal fixing is caused.

The other additives other than cerium oxide particles may be applied. Examples thereof include higher alcohol particles having 20 to 50 carbon atoms, peak of carbon atom number distribution being preferably 20-45. The higher alcohol particles preferably have straight chain component of 75 to 98%. Number average particle diameter of the higher alcohol particles is preferably 200 nm to 7.5 μm, more preferably 800 nm to 6.2 μm in view of anti-filming property.

The other preferable examples are hydrophobic processed inorganic oxide particles such as silica, titania and aluminum oxide, having number average particle diameter of 11 to 40 nm. It is further preferable to add silica particles having number average particle diameter of 80 to 150 nm in view of improving transfer ability and image quality.

A mixer such as V-type blender, Henschel mixer and Loedige mixer can be employed for adding the external additives. The external additives may be adhered to toner particles stepwise.

The toners of this invention are prepared by the above mentioned steps.

A charge control agent may be added to inside of the toners in addition to the colorant, the releasing agent, the crystalline polyester and the amorphous polyester described above.

Preferable examples of the charge control agent is oxycarboxylic acid complex such as salicylic acid complex and benzilic acid complex. Examples of the central metal composing the oxycarboxylic acid complex include aluminum, calcium, potassium and zinc. Quaternary ammonium compounds, Nigrosine compounds, azo complex dye of aluminum, iron or chromium and triphenylmethane pigments may be also included.

The toners according to this invention have volume based median particle diameter of preferably 4 to 9 μm. Toners having such particle size ensure to produce image having expected image density and high definition, and minimize fog in the background image area or stains due to toner scattering.

In the image forming method, toner may be employed in a single component developing agent in which the toner is employed individually, or may be in a double component developing agent in which the toner is combined with carriers. The toner may be employed as a magnetic single component developer in which the toner particles contain magnetic substance or a non-magnetic single component developer in which the toner particles contain no magnetic substance.

The above carriers employed for the double component developing agent are not particularly limited and resins coated carriers are employed which are described in JP-A Nos. 62-39879 and 56-11461.

The resin coated carrier is described. The preferable average particle diameter is appropriately 20 to 80 μm and more preferably 25 to 35 μm in view of obtaining high quality image and improving anti-filming property. Ferrite or magnetite particles are employed as a core particle composing the coated carrier, and ferrite is preferable. Preferable example of the ferrite includes Mn—Mg—Sr ferrite in view of inhibiting improper adhesion.

Resin of homopolymer or copolymer obtained by polymerization of the following monomer(s) are used for coating the above core particles. The monomer includes, for example,

(1) styrenes such as styrene, and α-methylstyrene;
(2) α-methylene fatty acid monocarboxylic acids such as methyl acrylate, ethyl acrylate, n-propyl acrylate, lauryl acrylate, 2-ethylhexyl acrylate, methyl methacrylate, methacrylic acid, n-propyl methacrylate, lauryl methacrylate, and 2-ethylhexyl methacrylate;
(3) nitrogen-containing acrylates such as dimethylaminoethyl methacrylate;
(4) vinylpyridines such as 2-vinylpyridine and 4-vinylpyridine;
(5) vinylnitriles such as acrylonitrile and methacrylonitrile;
(6) vinylethers such as vinyl methyl ether and vinyl isobutyl ether;
(7) vinylketones such as vinyl methyl ketone, vinyl ethyl ketone, and vinyl isopropenyl ketone;
(8) olefins such as ethylene and propylene; and
(9) vinyl based fluorine containing monomers such as vinylidene fluoride, tetrafluoroethylene and hexafluoroethylene.

The following resins can be employed; silicone resin such as methylsilicone or methylphenylsilicone, polyesters containing bisphenol or glycol, epoxy resins, polyurethane resins, polyamide resins, cellulose resins, polyether resins, or polycarbonate resins.

These resins may be employed individually or in combinations of at least two types. Styrene/cyclohexyl methacrylate copolymer having monomer content of 5:5 to 9:1 is preferable in view of minimized charge amount dependence on moisture. The resin containing about 5% by monomer of perfluoroacrylate is also preferable.

Having number average particle diameter of about 0.1 to 0.3 μm may be added to the resin coat layer in view of retarding abrasion of resin coat. Carbon black, graphite, titanium oxide or aluminum oxide may be added to the resin coat layer in an amount of about 5 to 30% for improving developing performance.

The amount of resins to be coated is usually 0.1-10 parts by weight with respect to the core particles, preferably 0.5-3.0 parts by weight.

Mixing ratio of amount of toner and carrier of the double component developer may be set optionally according to design of the image forming apparatus.

The electrophotographic image forming method employing the toners according to this invention is described. The image forming method comprises following steps.

(1) Latent image forming step to form an electrostatic latent image on an electrostatic latent image carrier (photoreceptor).
(2) Developing step to form a toner image by developing the electrostatic latent image formed on the electrostatic latent image carrier by employing the toners according to this invention.
(3). Transfer step to transfer the toner image formed on the electrostatic latent image carrier onto transferee sheet such as paper.
(4) Fixing step to fix the transferred toner image on the transferee.

The steps other than the above mentioned four steps may be included. It is preferable to include cleaning step to remove residual toners on the electrostatic latent image carrier after transfer step. Toner image may be transferred from the electrostatic latent image carrier to the recording medium through an intermediate transfer member.

The image forming method employing toners according to this invention realizes so called low temperature fixing and gives a high quality toner image having high glossiness. The toners of this invention can be maintains an excellent developing performance, transfer performance, fluidity and storage stability for long time. Energy consumption during the image forming can be reduced in comparison with conventional method due to low temperature fixing.

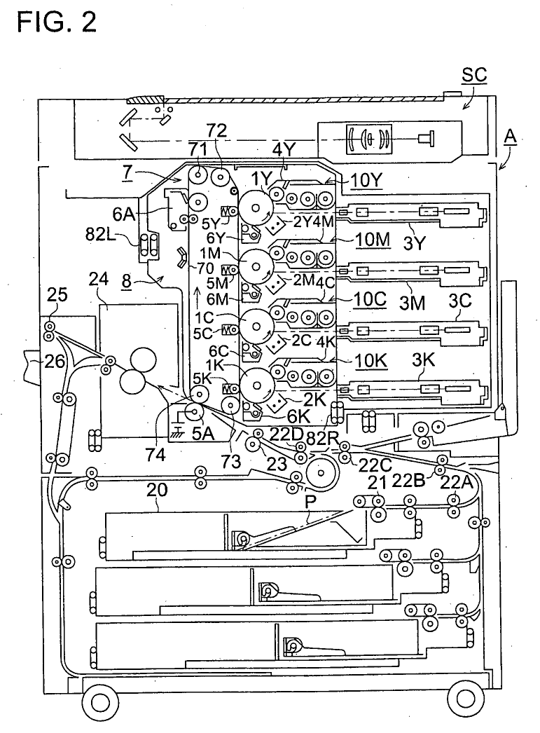

FIG. 2 shows a schematic view of an example of an image forming apparatus, to which the toners of this invention can be applied as double component developer.

FIG. 2 is a schematic diagram showing an example of an image forming apparatus to which the toners of the present invention can be applied when they are made double component developer.

In FIG. 2, each of 1Y, 1M, 1C and 1K is a photoreceptor, each of 4Y, 4M, 4C and 4K is a developing device, each of 5Y, 5M, 5C and 5K is a primary transfer roller, 5A is a secondary transfer roller, each of 6Y, 6M, 6C and 6K is a cleaning device, numeral 7 is an intermediate transfer unit, numeral 24 is a heat roll type fixing device and numeral 70 is an intermediate transfer member.

This image forming apparatus is called a tandem type color image forming apparatus, and it has therein plural sets of image forming sections 10Y, 10M, 10C and 10K, endless belt type intermediate transfer unit 7, endless belt type sheet feeding conveyance device 21 that conveys recording member P and heat roll type fixing device 24. On the upper part of main body A of the image forming apparatus, there is arranged document image reading device SC.

Image forming section 10Y that forms a yellow color image has therein drum-shaped photoreceptor 1Y, charging device 2Y arranged around photoreceptor 1Y, exposure device 3Y, developing device 4Y, primary transfer roller 5Y and cleaning device 6Y. Image forming section 10M that forms a magenta color image has therein drum-shaped photoreceptor 1M, charging device 2M arranged around the photoreceptor 1M, exposure device 3M, developing device 4M, primary transfer roller 5M and cleaning device 6M. Image forming section 10C that forms a cyan color image has therein drum-shaped photoreceptor 1C, charging device 2C arranged around photoreceptor 1C, exposure device 3C, developing device 4C, primary transfer roller 5C and cleaning device 6C.

Further, image forming section 10K that forms a black color image has therein drum-shaped photoreceptor 1K, charging device 2K arranged around photoreceptor 1K, exposure device 3K, developing device 4K, primary transfer roller 5K and cleaning device 6K.

Each of cleaning devices 6Y, 6M, 6C and 6K is preferably provided with a major cleaning member cleaning blade and a cleaning roller deposited prior to the cleaning blade which is made contact with remaining toner particles failed in transfer. The cleaning roller is composed of core metal and elastic material covering the core metal such as silicone rubber or urethane foam. The cleaning roller is made contact with the photoreceptor and may be idling driven with photoreceptor, or is preferably driven at a speed of 1.1 to 2.0 times of circumferential speed of the photoreceptor whereby filming is inhibited without wasting the photoreceptor.

The intermediate transfer unit 7 has endless belt type intermediate transfer member 70, which is rolled by plural rollers 71, 72, 73 and 74, supported and circulated.

Housing 8 can be drawn out from the apparatus body A, guided by supporting rails 82L and 82R.

In the housing 8, there are arranged the image forming sections 10Y, 10M, 10C, 10K, and the endless-belt shape intermediate transfer unit 7.

Images each having a different color formed respectively by image forming sections 10Y, 10M, 10C and 10K are transferred sequentially onto rotating endless belt type intermediate transfer member 70 respectively by primary transfer rollers 5Y, 5M, 5C and 5K, whereby a combined color image is formed. Recording member P such as a sheet loaded in sheet-feeding cassette 20 is fed by sheet-feeding conveyance device 21, to be conveyed to secondary transfer roller 5A through plural intermediate rollers 22A, 22B, 22C and 22D as well as registration roller 23, thus, the color images are transferred all together onto the recording member P. The recording member P onto which the color image has been transferred is fixed by heat roll type fixing device 24, and is interposed by sheet-ejection roller 25 to be placed on sheet-ejection tray 26 located outside the apparatus.

On the other hand, after the color image is transferred by second transfer roller 5A onto recording member P, toner remaining on endless belt type intermediate transfer member 70 is removed from endless belt type intermediate transfer member 70 via curvature separation of recording member P, by cleaning device 6A.

cleaning devices 6A is preferably provided with a major cleaning member cleaning blade and a cleaning roller deposited prior to the cleaning blade which is made contact with remaining toner particles failed in transfer. The cleaning roller is composed of core metal and elastic material covering the core metal such as silicone rubber or urethane foam. The cleaning roller is made contact with the intermediate transfer member and may be idling driven with intermediate transfer member, or is preferably driven at a speed of 1.1 to 2.0 times of running speed of the intermediate transfer member whereby filming is inhibited without wasting the photoreceptor.

During image forming processing, primary transfer roller 5K is constantly in pressure contact with photoreceptor 1K. Other primary transfer rollers 5Y, 5M and 5C are in pressure contact respectively with corresponding to photoreceptors 1Y, 1M and 1C only in the course of color image forming.

Second transfer roller 5A comes in contact with endless belt type intermediate transfer member 70 only when recording member P passes through second transfer roller 5A and the secondary transfer is carried out.

In this way, a toner image is formed on each of photoreceptors 1Y, 1M, 1C and 1K through charging, exposure and developing, then, toner images having respective colors are superimposed each other on endless belt type intermediate transfer member 70, and they are transferred all together onto recording member P, to be fixed by heat roll type fixing device 24 through application of pressure and heating. Each of photoreceptors 1Y, 1M, 1C and 1K, after the toner image thereon has been transferred onto recording member P, is cleaned by cleaning means 6A to remove remaining toner on the photoreceptor during transferring, and then, the photoreceptors enter the above-described cycle of charging, exposure and developing so that succeeding image forming may be carried out.

Full color image forming method employing a nonmagnetic single component developer can be realized by, for example, employing an image forming apparatus in which the developing device 4 for double component developer is replaced by one for a single component developer.

Fixing method may be selected from a roller-fixing method employing a heating roller and a pressure roller, a method employing a heating roller and a pressure belt or a belt fixing method employing a heating belt and a pressure belt. An example of the heating method for the fixing method includes one employing a halogen lamp and IH.

### EXAMPLES

The invention is concretely described below referring examples but the invention is not limited to contents of the description. In the following description, “part” means “part by weight”. The following measurement methods were applied in the production processes of the toners, carriers and developers used for the examples and the comparative examples.

### (Volume-Based Median Particle Diameter of Resin Particles or Colorant Fine Particles)

The volume-based median particle diameter (D50) of the resin particles or the colorant fine particles was determined by a dynamic light scattering method using microtruck UPA-150, manufactured by Nikkiso Co., Ltd. In concrete, the measurement was carried out as follows. Several drops of resin particles to be measured were put in a 50 ml mess cylinder and 25 ml of purified water was added and dispersed by an ultrasonic washing machine US-1, manufactured by As One Corp., for 3 minutes to prepare a measuring sample. Then 3 ml of the measuring sample was put in a cell of Microtruck UPA-150 and it was confirmed that the value of Sample Loading was within the range of from 0.1 to 100 and then the measurement was performed under the following conditions.

### Measurement Conditions

Transparency: Yes

Refractive index: 1.59

Particle density: 1.05 gm/cm³

Spherical particles: Yes

### Solvent Conditions

Refractive index: 1.33

Viscosity: High (temp) 0.797×10⁻³ Pa·S
Low (temp) 1.002×10⁻³ Pa·S

### (Volume-Based Median Particle Diameter of Toner Particles)

The volume-based median particle diameter was measured and calculated by using Coulter Multisizer III, manufactured by Beckman Coulter Inc.

The measuring procedure was as follows. For dispersing the toner, 0.02 g of the toner was wetted by 20 ml of a surfactant solution, for example a solution prepared by diluting by 10 times a neutral detergent containing a surfactant with purified water, and dispersed by ultrasonic wave for 1 minute to prepare a toner dispersion. The resultant toner dispersion was put into a beaker containing ISOTON II, manufactured by Beckman Coulter Inc., set on the sample stand by a pipette until the density indicated on the measuring apparatus reached within the range of from 5 to 10%. Measuring results with high repeatability can be obtained within such the range. On the apparatus, Counting particle number and the aperture diameter were each set at 25,000 and 50 μm, respectively, and the particle diameter frequency was calculated by dividing the measuring range of from 1 to 30 μm into 256 sections. The volume-based median particle diameter was defined by the particle diameter at a volume integration ratio of 50% from the larger side of the diameter.

### (Measurement of Primary Particle Diameter of External Additive)

The primary particle diameter of the external additive was measured on a photograph which was taken by that the toner particles were sprinkling onto a carbon or copper grid for transmission type electron microscope and the external additive particles being at the circumference portion of the toner particle was photographed by a transmission type electron microscope. The observation could be carried out by using transmission type electron microscopes commonly known by skilled ones such as LEM-2000, manufactured by Topcon Corp., and JEM-2000FX, manufactured by JOEL Ltd. The photographing was carried out at a magnitude of 50,000, at which the cross section of one particle could be included in, the field of vision. Then the Fere diameters of the external additive particles were measured and mathematic average of 100 particles was calculated. On this occasion, the composition of external additive could be distinctively determined by elemental analyzing by the x-ray microanalyzer attached with the transmission type electron microscope.

### (Measurement of Molecular Weight of Amorphous Polyester Resin and Crystalline Polyester Resin)

The molecular weights of the amorphous polyester resin and that of the crystalline polyester resin were measured by a gel permeation chromatographic (GPC) method. A measuring apparatus HLC-9120CPC, SC-8020, manufactured by Tosoh Corp., two of TSK gel, Super HM-H (6.0 mm ID×15 cm) columns, manufactured by Tosoh Corp., and a solvent of tetrahydrofuran (THF) were used.

The measurement was carried out at a sample concentration of 0.5%, a flow rate of 0.6 ml/minute, a sample injection amount of 10 μl and a measuring temperature of 40° C., and using an IR detector. A calibration curve was prepared from 10 polystyrene TSK standard samples, A-500, F-1, F-10, F-80, F-380, A-2500, F-4, F-40, F-128 and F-700, each manufactured by Tosoh Corp.

### 1. Preparation of Various Dispersions

(Preparation of Amorphous Polyester Resin Particle Dispersion 1)

| | | |
|---|---|---|
| Bisphenol A-propylene oxide adduct (Average addition | 140 | pats |
| mole number: 2) | | |
| Bisphenol A-ethylene oxide adduct (Average addition | 60 | parts |
| mole number: 2) | | |
| Dimethyl isophthalate | 40 | parts |
| Terephthalic acid | 70 | parts |

The above Compound Group A and 0.12 parts of catalyst of dibutyl tin oxide were put into a three-mouthed flask dried by heating and air pressure in the flask was reduced and the atmosphere in the flask was made to inactive by nitrogen gas and then the contents of flask were refluxed at 1-80° C. for 6 hours while mechanically stirring. After that, the reacting system was stirred for 5 hours while gradually raising the temperature until 200° C. by reduced pressure distillation. The molecular weight was measured when the contents became viscous liquid and the reduced pressure distillation was stopped and the contents were cooled by air when the weight average molecular weight of the polymer was reached at 13,700 to obtain Amorphous Polyester Resin 1. The glass transition temperature of Amorphous Polyester resin 1 was 63.0° C.

After that, Amorphous Polyester Resin 1 in a melted state was transferred to CAVITRON CD1010, manufactured by Eurotec Ltd, at a rate of 100 g/minute. Besides, diluted ammonia water of 0.37% by weight prepared by diluting reagent ammonia water by deionized water was put in an aqueous medium tank and heated by 120° C. by a heat exchanger and transferred to the CAVITRON at a rate of 0.1 l/minute simultaneously with the amorphous polyester resin. CAVITRON was driven in such the situation under conditions of a rotation frequency of rotator of 60 Hz (3,600 rpm, circumference speed of rotator of 12.9 m/sec) and a pressure of 4.9×10⁵ Pa to prepare Amorphous Polyester Resin Particle Dispersion 1 having a volume average particle diameter of 0.28 μm, and the moisture content was controlled so that the resin particle concentration was made to 20% by weight.

(Preparation of Amorphous Polyester Resin Particle Dispersion 2)

| | | |
|---|---|---|
| Bisphenol A-propylene oxide adduct (Average addition | 140 | pats |
| mole number: 2.2) | | |
| Bisphenol A-ethylene oxide adduct (Average addition mole | 70 | parts |
| number: 2) | | |
| Dimethyl isophthalate | 30 | parts |
| Terephthalic acid | 50 | parts |
| Dodecenylsuccinic acid | 50 | parts |

Amorphous Polyester Resin 2 having a weight average molecular weight of 18,100 and a glass transition temperature of 59.6° C. was prepared in the same manner as in Amorphous Polyester Resin 1 except that the Compound Group A was replaced by the above Compound Group B.

Amorphous Polyester Resin Dispersion 2 having a volume average particle diameter of 0.14 μm was prepared by subjecting thus obtained Amorphous Polyester Resin 2 to emulsifying dispersion treatment by CAVITRON under the condition the same as in the preparation of Amorphous Polyester Resin Particle Dispersion 1. The moisture content was controlled so that the resin particle concentration was made to 20% by weight.

### (Preparation of Crystalline Polyester Resin Particle Dispersion 1)

The group of the following compounds was referred to as Compound Group C.

| | |
|---|---|
| 1,8-sebacinediacid | 200 parts |
| 1,6-hexanediol | 120 parts |

The above Compound group C and a catalyst of tetrabutoxy titanium (Ti(OBu)₄) in an amount of 0.014% by weight of 1,8-sebacinediacid were put into a three-mouthed flask dried by heating and air pressure in the flask was reduced and made to inactive atmosphere by nitrogen gas and then the contents of flask were refluxed at 180° C. for 5 hours while mechanically stirring. After that, the reacting system was stirred for 5 hours while gradually raising temperature until 200° C. by reduced pressure distillation. The molecular weight was measured when the content became viscous liquid and the reduced pressure distillation was stopped and the content was cooled by air when the weight average molecular weight was reached at 15,000 to obtain Crystalline Polyester Resin 1. The melting point of Crystalline Polyester resin was 90° C.

After that, Crystalline Polyester Resin 1 in a melted state was transferred at a rate of 100 g/minute to CAVITRON CD1010, manufactured by Eurotec Ltd. Besides, diluted ammonia water of 0.37% by weight prepared by diluting reagent ammonia water by deionized water was put in an aqueous medium tank and heated by 120° C. by a heat exchanger and transferred to the CAVITRON simultaneously with the amorphous polyester resin at a rate of 0.1 l/minute. CAVITRON was driven in such the situation under conditions of a rotation frequency of rotator of 60 Hz and a pressure of 4.9×10⁵ Pa to prepare Crystalline Polyester Resin Particle Dispersion 1 having a volume average particle diameter of 0.26 μm, and the moisture content was controlled so that the resin particle concentration was made to 20% by weight.

### (Preparation of Crystalline Polyester Resin Particle Dispersion 2)

Crystalline Polyester Resin Particle Dispersion 2 having a weight average molecular weight of 18.500 was prepared in the same manner as in the preparation of Crystalline Polyester Resin Particle Dispersion 1 except that the monomers were replaced by the following monomers.

| | |
|---|---|
| 1,10-dodecanediacid | 200 parts |
| Nonanediol | 140 parts |

The melting point of Crystalline Polyester Resin 2 was 65° C.

Crystalline Polyester Resin Dispersion 2 having a volume average particle diameter of 0.23 μm was prepared by subjecting thus obtained Amorphous Polyester Resin 2 to emulsifying dispersion treatment by CAVITRON under the condition the same as in the preparation of Crystalline Polyester Resin Particle Dispersion 1. The moisture content was controlled so that the resin particle concentration was made to 20% by weight.

(Preparation of Cyan Colorant Dispersion C1)

| | |
|---|---|
| C.I. Pigment Blue 15:3 | 50 parts |
| Ionic surfactant (sodium n-dodecylbenzenesulfonate) | 8 parts |
| Deionized water | 250 parts |

The above composition was mixed and dissolved and dispersed for a homogenizer ULTRA TURRAX T50, manufactured by IKA for 10 minutes and further treated by ultrasonic wave for 20 minutes to prepared Cyan Colorant Dispersion C1 in which colorant particles having a volume-based median particle diameter of 180 nm were dispersed.

### (Preparation of Cyan Colorant Dispersion C2)

Cyan Colorant Dispersion C2 in which colorant particles having a volume-based median particle diameter of 324 nm were dispersed was prepared in the same manner as in the preparation of Cyan Colorant Dispersion C1 except that 50 parts of C.I. Pigment Blues 15:3 was replaced by 50 parts of C.I. Pigment Blue 15:2.

### (Preparation of Cyan Colorant Dispersion C3)

Cyan Colorant Dispersion C3 in which colorant particles having a volume-based median particle diameter of 266 nm were dispersed was prepared in the same manner as in the preparation of Cyan Colorant Dispersion C1 except that 50 parts of C.I. Pigment Blues 15:3 was replaced by 50 parts of C.I. Pigment Blue 15:1.

(Preparation of Comparative Cyan Colorant Dispersion c1)

Comparative Cyan Colorant Dispersion c1 in which colorant particles having a volume-based median particle diameter of 413 nm were dispersed was prepared in the same manner as in the preparation of Cyan Colorant Dispersion C1 except that the colorant was replaced by 50 parts of C.I. Pigment Blue 25.

### (Preparation of Comparative Cyan Colorant Dispersion C2)

Comparative Cyan Colorant Dispersion c3 in which colorant particles having a volume-based median particle diameter of 502 nm were dispersed was prepared in the same manner as in the preparation of Cyan Colorant Dispersion C1 except that the colorant was replaced by 50 parts of C.I. Pigment Blue 56.

### (Preparation of Comparative Cyan Colorant Dispersion C3)

Comparative Cyan Colorant Dispersion c3 in which colorant particles having a volume-based median particle diameter of 487 nm were dispersed was prepared in the same manner as in the preparation of Cyan Colorant Dispersion C1 except that the colorant was replaced by 50 parts of C.I. Pigment Blue 61.

(Preparation of Magenta Colorant Dispersion M1)

| | |
|---|---|
| C.I. Pigment Red 122 | 30 parts |
| C.I. Pigment red 238 | 20 parts |
| Ionic surfactant (sodium n-dodecylbenzenesulfonate) | 8 parts |
| Deionized water | 250 parts |

The above composition was mixed and dissolved and dispersed for a homogenizer ULTRA TURRAX T50, manufactured by IKA for 10 minutes and further treated by ultrasonic wave for 20 minutes to prepared Magenta Colorant Dispersion M1 in which colorant particles having a volume-based median particle diameter of 210 nm were dispersed.

### (Preparation of Magenta Colorant Dispersion M2)

Magenta Colorant Dispersion M2 was prepared in the same manner as in Magenta Colorant Dispersion M1 except that the colorants were replaced by the followings.

| | |
|---|---|
| C.I. Pigment Red 122 | 25 parts |
| C,I, Pigment Red 238 | 25 parts |

Magenta Colorant Dispersion M2 contained colorant particles having a volume-based median particle diameter of 221 nm.

### (Preparation of Magenta Colorant Dispersion M3)

Magenta Colorant Dispersion M3 was prepared in the same manner as in Magenta Colorant Dispersion M1 except that the colorants were replaced by the followings.

| | |
|---|---|
| C.I. Pigment Red 122 | 35 parts |
| C,I, Pigment Red 238 | 15 parts |

Magenta Colorant Dispersion M3 contained colorant particles having a volume-based median particle diameter of 216 nm.

(Preparation of Comparative Magenta Colorant Dispersion m1)

Comparative Magenta Colorant Dispersion m1 was prepared in the same manner as in Magenta Colorant Dispersion M1 except that the colorants were replaced by the following.

| | |
|---|---|
| C.I. Pigment Red 122 | 50 parts |

Magenta Colorant Dispersion m1 contained colorant particles having a volume-based median particle diameter of 226 nm.

(Preparation of Comparative Magenta Colorant Dispersion m2)

Comparative Magenta Colorant Dispersion m2 in which colorant particles having a volume-based median particle diameter of 285 nm were dispersed was prepared in the same manner as in Magenta Colorant Dispersion M1 except that the colorants were replaced by the followings.

| | |
|---|---|
| C.I. Pigment Red 122 | 30 parts |
| C.I. Pigment Red 245 | 20 parts |

(Preparation of Comparative Magenta Colorant Dispersion m3)

Comparative Magenta Colorant Dispersion m3 in which colorant particles having a volume-based median particle diameter of 305 nm were dispersed was prepared in the same manner as in Magenta Colorant Dispersion M1 except that the colorants were replaced by the followings.

| | |
|---|---|
| C.I. Pigment Red 122 | 30 parts |
| C.I. Pigment Red 235 | 20 parts |

(Preparation of Yellow Colorant Dispersion Y1)

| | |
|---|---|
| C.I. Pigment Yellow 74 | 50 parts |
| Ionic surfactant (sodium n-dodecylbenzenesulfonate) | 8 parts |
| Deionized water | 250 parts |

The above composition was mixed and dissolved and dispersed for a homogenizer ULTRA TURRAX T50, manufactured by IKA, for 10 minutes and further treated by ultrasonic wave for 20 minutes to prepared Yellow Colorant Dispersion Y1 in which colorant particles having a volume-based median particle diameter of 250 nm were dispersed.

(Preparation of Comparative Yellow Colorant Dispersion y1)

Comparative Yellow Colorant Dispersion y1 in which colorant particles having a volume-based median particle diameter of 299 nm were dispersed was prepared in the same manner as in the preparation of Yellow Colorant Dispersion Y1 except that 50 parts of C.I. Pigment Yellow 139 was used.

(Preparation of Comparative Yellow Colorant Dispersion y2)

Comparative Yellow Colorant Dispersion y2 in which colorant particles having a volume-based median particle diameter of 305 nm were dispersed was prepared in the same manner as in the preparation of Yellow Colorant Dispersion Y1 except that 50 parts of C.I. Pigment Yellow 93 was used.

(Preparation of Comparative Yellow Colorant Dispersion y3)

Comparative Yellow Colorant Dispersion y3 in which colorant particles having a volume-based median particle diameter of 341 nm were dispersed was prepared in the same manner as in the preparation of Yellow Colorant Dispersion Y1 except that 50 parts of C.I. Pigment Yellow 181 was used.

(Preparation of Black Colorant Dispersion K1)

| | |
|---|---|
| Carbon Black, Regal 330 (Cabot Corp.) | 10 parts |
| C.I. Pigment Blue 15:3 | 40 parts |
| Ionic surfactant (sodium n-dodecylbenzenesulfonate) | 8 parts |
| Deionized water | 250 parts |

The above composition was mixed and dispersed for 10 minutes by the homogenizer ULTRA TURRAX T50, manufactured by IKA, to prepare Black Colorant Dispersion K1 in which the colorant particles having a volume-based median particle diameter of 310 nm.

### (Preparation of Black Colorant Dispersion K2)

Comparative Black Colorant Dispersion K2 was prepared in the same manner as in Black Colorant Dispersion K1 except that amount of the Carbon Black Regal 330 (Cabot Corp.) was changed to 20 parts, and 40 parts of C.I. Pigment Blue 15:3 was replaced by 30 parts of C.I. Pigment Blue 15:2. Black Colorant Dispersion K2 contained the colorant particles having a volume-based median particle diameter of 302 nm.

### (Preparation of Black Colorant Dispersion K3)

Comparative Black Colorant Dispersion K3 was prepared in the same manner as in Black Colorant Dispersion K1 except that amount of the Carbon Black Regal 330 (Cabot Corp.) was changed to 25 parts, and 40 parts of C.I. Pigment Blue 15:3 was replaced by 25 parts of C.I. Pigment Blue 15:1. Black Colorant Dispersion K2 contained the colorant particles having a volume-based median particle diameter of 302 nm.

### (Preparation of Comparative Black Colorant Dispersion K1)

Comparative Black Colorant Dispersion k1 was prepared in the same manner as in Black Colorant Dispersion K1 except that the colorants were changed to 50 parts of Carbon Black Regal 330 (Cabot Corp.) and C.I. Pigment Blue 15:3 was not employed.

(Preparation of Releasing Agent Dispersion 1)

| | |
|---|---|
| Paraffin wax FNP0090 (Nippon Seiro Co., Ltd.) (Melting | 10 parts |
| point: 90.2° C.) | |
| Pentaerythritol tetrabehenate | 50 parts |
| Ionic surfactant (Sodium i-benzenesulfonate) | 5 parts |
| Deionized water | 200 parts |

The above composition was mixed, dissolved and heated by 95° C., and then dispersed for 10 minutes by the homogenizer ULTRA TURRAX, manufactured by IKA, and treated by a press-extrusion type Gaulin homogenizer to prepare Releasing agent Dispersion 1. In Releasing agent Dispersion 1, the solid content was 20% by weight and a volume-based median particle diameter of the releasing agent particles was 220 nm.

### (Preparation of Releasing Agent Dispersion 2)

Releasing agent Dispersion 2 having a volume-based median particle diameter of 210 nm and a solid content of 20% by weight was prepared in the same manner as in Releasing agent Dispersion 1 except that Paraffin wax FNP0090 was replaced by behenyl behenate.

### 2. Preparation of Toner

(Preparation of Toner C-1)

| | |
|---|---|
| Amorphous polyester Resin Dispersion | 560 parts |
| Crystalline Polyester resin Dispersion | 240 parts |
| Colorant Dispersion C1 | 80 parts |
| Releasing agent Dispersion 2 | 100 parts |

The above components were put into a spherical stainless steel flask and adjusted to 20° C. while stirring together with 300 parts of deionized water and sufficiently mixed and dispersed by the homogenizer ULTRA TURRAX T50 to obtain dispersion. Then 0.1 parts of aluminum polychloride was added to the dispersion and the dispersing treatment by ULTRA TURRAX was continued. After that, the flask was immersed in a heating oil bath and heated by 45° C. while stirring. The flask was kept at 45° C. for 60 minutes and 200 parts of Amorphous Polyester Resin Particle Dispersion was gradually added to the dispersion.

Moreover, tetrasodium ethylenediaminetetraacetate tetrahydrate in an amount corresponding 1% by weight of the solid component of the dispersion was added and then pH of the system was adjusted to 8 by a 0.5 mol/L sodium hydroxide solution. After that, the stain steel flask was tightly sealed and heat up by 90° C. while stirring through magnetic seal and pH of the system was adjusted to 7 by using a 0.5 mol/L nitric acid and the temperature was kept for 30 minutes to continue the reaction.

After finish of the reaction, the reaction system was rapidly cooled by 30° C. by a multi-pipe heat exchanger using cooling water of 5° C. while controlling the flowing amount of cooling water so as to make the cooling rate to −25° C./minute. After rapidly cooled, the solid component was filtered and sufficiently washed by deionized water and separated from the liquid by vacuum filtration using Buchner funnel. Thus separated particles were re-dispersed in 3 liters of deionized water of 43° C. and washed by stirring for 15 minutes at 300 rpm.

Such the procedure was further repeated for 5 times and the solid component was separated from the liquid by vacuum filtration using by Buchner funnel with No. 5A filter paper when the pH and electric conductivity of the filtrate were each reached at 6.6 and 12 μS/cm, respectively. Vacuum drying of the solid component was continued for 12 hours and the dried powder was subjected to the following external additive treatment.

| | |
|---|---|
| Cerium oxide particles (Primary particle diameter: 350 nm) | 2.5 parts |
| Titania particle treated by dodecyltrimethoxysilane | 0.8 parts |
| (Volume-based median particle diameter: 30 nm) | |
| Silica particle treated by hexamethyldisilane (Volume- | 1.2 parts |
| based median particle diameter: 100 nm) | |

The above additives were added to 100 parts of each of the toner particle and treated by mixing by 5 L Henschel mixer, manufactured by Mituimiike Kakouki Co., Ltd., for 10 minutes for external additive treatment. The resultant powder was classified by a wind sieving machine HIBOLTER NR300, manufactured by Shin Tokyo Kikai Co., Ltd., with an opening size of 45 μm. Thus Cyan Toner C-1 was obtained.

The volume-based median particle diameter of Cyan Toner C-1 was 6.5 μm.

(Preparation of Cyan Toners C-2 and C-3, Comparative Cyan Toners c-1 to c-3, Magenta Toners M-1 to M3, Comparative Magenta Toners m-1 to m-3, Yellow Toner Y-1, Comparative Yellow Toners y-1 to y-3, Black Toners K-1 to K-3 and Comparative Toner k-1)

Cyan Toner C-2 was prepared in the same manner as in Cyan Toner C-1 except that Cyan Colorant Dispersion C1 was replaced by Cyan Colorant Dispersion C2. The volume-based median particle diameter of Cyan Toner C-2 was 6.6 μm.

Furthermore, Cyan Toner C-3 was prepared in the same manner as in Cyan Toner C-1 except that Cyan Colorant Dispersion C1 was replaced by Cyan Colorant Dispersion C3. The volume-based median particle diameter of Cyan Toner C-2 was 6.5 μm.

(Preparation of Comparative Cyan Toner c-1)

Comparative Cyan Toner c-1 was prepared in the same manner as in Cyan Toner C-1 except that Cyan Colorant Dispersion C1 was replaced by Comparative Cyan Colorant Dispersion c1. The volume-based median particle diameter of Comparative Cyan Toner c-1 was 6.4 μm.

(Preparation of Comparative Cyan Toner c-2)

Comparative Cyan Toner c-2 was prepared in the same manner as in Cyan Toner C-1 except that Cyan Colorant Dispersion C1 was replaced by Comparative Cyan Colorant Dispersion c2. The volume-based median particle diameter of Comparative Cyan Toner c-2 was 6.6 μm.

(Preparation of Comparative Cyan Toner c-3)

Comparative Cyan Toner c-3 was prepared in the same manner as in Cyan Toner C-1 except that Cyan Colorant Dispersion C1 was replaced by Comparative Cyan Colorant Dispersion c3. The volume-based median particle diameter of Comparative Cyan Toner c-3 was 6.5 μm.

### (Preparation of Magenta Toners M-1 to M-3)

Magenta Toner M-1 was prepared in the same manner as in Cyan Toner C-1 except that Cyan Colorant Dispersion C1 was replaced by Magenta Colorant Dispersion M1. The volume-based median particle diameter of Magenta Toner M-1 was 6.5 μm.

Magenta-Toner M-2 was prepared in the same manner as in Cyan Toner C-1 except that Cyan Colorant Dispersion C1 was replaced by Magenta Colorant Dispersion M2. The volume-based median particle diameter of Magenta Toner M-2 was 6.3 μm.

Moreover, Magenta Toner M-3 was prepared in the same manner except that Magenta Colorant Dispersion M3 was used. The volume-based median particle diameter of Magenta Toner M-1 was 6.5 μm.

(Preparation of Comparative Magenta Toner m-1)

Comparative Magenta Toner m-1 was prepared in the same manner as in Cyan Toner C-1 except that Cyan Colorant Dispersion C1 was replaced by Comparative Magenta Colorant Dispersion m1. The volume-based median particle diameter of Comparative Magenta Toner m-1 was 6.6 μm.

(Preparation of Comparative Magenta Toner m-2)

Comparative Magenta Toner m-1 was prepared in the same manner as in Cyan Toner C-1 except that Cyan Colorant Dispersion C1 was replaced by Comparative Magenta Colorant Dispersion m2. The volume-based median particle diameter of Comparative Magenta Toner m-2 was 6.6 μm.

(Preparation of Comparative Magenta Toner m-3)

Comparative Magenta Toner m-3 was prepared in the same manner as in Cyan Toner C-1 except that Cyan Colorant Dispersion C1 was replaced by Comparative Magenta Colorant Dispersion m3. The volume-based median particle diameter of Comparative Magenta Toner m-3 was 6.5 μm.

### (Preparation of Yellow Toner Y-1)

Yellow Toner Y-1 was prepared in the same manner as in Cyan Toner C-1 except that Cyan Colorant Dispersion C1 was replaced by Yellow Colorant Dispersion Y1. The volume-based median particle diameter of Yellow Toner Y-1 was 6.5 μm.

(Preparation of Comparative Yellow Toner y-1)

Comparative Yellow Toner y-1 was prepared in the same manner as in Cyan Toner C-1 except that Cyan Colorant Dispersion C1 was replaced by Comparative Yellow Colorant Dispersion y1. The volume-based median particle diameter of Comparative Yellow Toner y-1 was 6.4 μm.

(Preparation of Comparative Yellow Toner y-2)

Comparative Yellow Toner y-2 was prepared in the same manner as in Cyan Toner C-1 except that Cyan Colorant Dispersion C1 was replaced by Comparative Yellow Colorant Dispersion y2. The volume-based median particle diameter of Comparative Yellow Toner y-2 was 6.4 μm.

(Preparation of Comparative Yellow Toner y-3)

Comparative Yellow Toner y-3 was prepared in the same manner as in Cyan Toner C-1 except that Cyan Colorant Dispersion C1 was replaced by Comparative Yellow Colorant Dispersion y3. The volume-based median particle diameter of Comparative Yellow Toner y-3 was 6.5 μm.

### (Preparation of Black Toners K-1 to K-3)

Black Toner K-1 was prepared in the same manner as in Cyan Toner C-1 except that Cyan Colorant Dispersion C1 was replaced by Black Colorant Dispersion K1. The volume-based median particle diameter of Black Toner K-1 was 6.5 μm.

Black Toner K-2 was prepared in the same manner as in Cyan Toner C-1 except that Cyan Colorant Dispersion C1 was replaced by Black Colorant Dispersion K2. The volume-based median particle diameter of Black Toner K-2 was 6.3 μm.

Moreover, Black Toner K-3 was prepared in the same manner except that Black Colorant Dispersion K3 was used. The volume-based median particle diameter of Black Toner K-3 was 6.5 μm.

(Preparation of Comparative Black Toner k-1)

Comparative Black Toner k−1 was prepared in the same manner as in Cyan Toner C-1 except that Cyan Colorant Dispersion C1 was replaced by Comparative Black Colorant Dispersion k1. The volume-based median particle diameter of Comparative Black Toner k-1 was 6.4 μm.

The toners are shown in Table 1.

In the following tables terms are abbreviated as follow.

“P.B.”, “P.R”, “P.Y.” and “C.B” show Pigment Blue, Pigment Red, Pigment Yellow and carbon black, respectively, in column of colorant.

“Amorphous 1”, “Amorphous 2”, “Crystalline 1” and “Crystalline 2” show Amorphous polyester resin 1, Amorphous polyester resin 2, Crystalline polyester resin 1 and Crystalline polyester resin 2, respectively.

TABLE 1

| Toner | Colorant | | D50 | Resin particle | Resin particle | | | | |
|---|---|---|---|---|---|---|---|---|---|
| Particle | Dispersion | Colorant | (μm) | dispersion (1) | dispersion (2) | *1 | External Additive | | |
| C-1 | C1 | P.B.15:3 | 6.5 | Amorphous 1 | Crystalline 1 | 2 | Cerium oxide | Titania | Silica |
| C-2 | C2 | P.B.15:2 | 6.6 | Amorphous 1 | Crystalline 1 | 2 | Cerium oxide | Titania | Silica |
| C-3 | C3 | P.B.15:1 | 6.5 | Amorphous 1 | Crystalline 1 | 2 | Cerium oxide | Titania | Silica |
| Comp. c-1 | Comp. c1 | P.B.25 | 6.4 | Amorphous 1 | Crystalline 1 | 2 | Cerium oxide | Titania | Silica |
| Comp. c-2 | Comp. c2 | P.B.56 | 6.6 | Amorphous 1 | Crystalline 1 | 2 | Cerium oxide | Titania | Silica |
| Comp. c-3 | Comp. c3 | P.B.61 | 6.5 | Amorphous 1 | Crystalline 1 | 2 | Cerium oxide | Titania | Silica |
| M-1 | M1 | P.R.122/P.R.238 | 6.5 | Amorphous 1 | Crystalline 1 | 2 | Cerium oxide | Titania | Silica |
| M-2 | M2 | P.R.122/P.R.238 | 6.3 | Amorphous 1 | Crystalline 1 | 2 | Cerium oxide | Titania | Silica |
| M-3 | M3 | P.R.122/P.R.238 | 6.5 | Amorphous 1 | Crystalline 1 | 2 | Cerium oxide | Titania | Silica |
| Comp. m-1 | Comp. m1 | P.R.122 | 6.6 | Amorphous 1 | Crystalline 1 | 2 | Cerium oxide | Titania | Silica |
| Comp. m-2 | Comp. m2 | P.R.122/P.R.245 | 6.6 | Amorphous 1 | Crystalline 1 | 2 | Cerium oxide | Titania | Silica |
| Comp. m-3 | Comp. m3 | P.R.122/P.R.253 | 6.5 | Amorphous 1 | Crystalline 1 | 2 | Cerium oxide | Titania | Silica |
| Y-1 | Y1 | P.Y.74 | 6.5 | Amorphous 1 | Crystalline 1 | 2 | Cerium oxide | Titania | Silica |
| Comp. y-1 | Comp. y1 | P.Y.39 | 6.4 | Amorphous 1 | Crystalline 1 | 2 | Cerium oxide | Titania | Silica |
| Comp. y-2 | Comp. y2 | P.Y.93 | 6.4 | Amorphous 1 | Crystalline 1 | 2 | Cerium oxide | Titania | Silica |
| Comp. y-3 | Comp. y3 | P.Y.181 | 6.5 | Amorphous 1 | Crystalline 1 | 2 | Cerium oxide | Titania | Silica |
| K-1 | K1 | CB/P.B.15:3 | 6.5 | Amorphous 1 | Crystalline 1 | 2 | Cerium oxide | Titania | Silica |
| K-2 | K2 | CB/P.B.15:2 | 6.3 | Amorphous 1 | Crystalline 1 | 2 | Cerium oxide | Titania | Silica |
| K-3 | K3 | CB/P.B.15:1 | 6.5 | Amorphous 1 | Crystalline 1 | 2 | Cerium oxide | Titania | Silica |
| Comp. k-1 | Comp. k1 | CB | 6.4 | Amorphous 1 | Crystalline 1 | 2 | Cerium oxide | Titania | Silica |

*1: Releasing Agent Dispersion No.

(Preparation of Toner Particle C-4)

| | |
|---|---|
| Amorphous Polyester Resin Particle Dispersion 2 | 500 parts |
| Crystalline Polyester Resin Particle Dispersion 2 | 200 parts |
| Cyan Colorant Dispersion C1 | 70 parts |
| Releasing agent Dispersion 1 | 85 parts |

The above composition was put into a spherical stainless steel flask and stirred together with 500 parts of deionized water and adjusted to 20° C. Then the flask was immersed in a heating oil bath and 0.5 parts of aluminum polychloride was added while the content was dispersed by the homogenizer ULTRA TURRAX T50. After the addition, the temperature was raised by 45° C. and kept for 50 minutes, and then 250 parts of Amorphous Polyester Resin Particle Dispersion 2 was added and further kept for 30 minutes.

After that, 1.20 of the solid component in the dispersion of tetrasodium ethylenediaminetetraacetate tetrahydrate was added and the pH value was adjusted to 8.0 by adding a 0.5 mol/L sodium hydroxide solution. The treatments thereafter were carried out in the same manner as in the preparation of Toner Particle C-1 to obtain Toner particle C-4 having a volume-based median particle diameter of 6.4 μm.

(Preparation of Cyan Toners C-5 and C-6, Comparative Cyan Toners c-4 to c-6, Magenta Toners M-4 to M-6, Comparative Magenta Toners m-4 to m-6, Black Toners K-4 to K-6 and Comparative Black Toner k-2)

Cyan Toners C-5 and C-6, Comparative Cyan Toners c-4 to c-6, Magenta Toners M-4 to M-6, Comparative Magenta Toners m-4 to m-6, Black Toners K-4 to K-6 and Comparative Black Toner were each prepared by the combinations listed in Table 2 in the same manner as in Cyan Toner C-4 except that Amorphous Polyester Dispersion 1, Crystalline Polyester resin Particle Dispersion 1 and Releasing agent dispersion 2 were each replace by Amorphous Polyester Dispersion 2, Crystalline Polyester resin Particle Dispersion 2 and Releasing agent dispersion 1, respectively. The toners are shown in Table 2.

TABLE 2

| Toner | Colorant | | D50 | Resin particle | Resin particle | | | | |
|---|---|---|---|---|---|---|---|---|---|
| Particle | Dispersion | Colorant | (μm) | dispersion (1) | dispersion (2) | *1 | External Additive | | |
| C-4 | C1 | P.B.15:3 | 6.6 | Amorphous 2 | Crystalline 2 | 1 | Cerium oxide | Titania | Silica |
| C-5 | C2 | P.B.15:2 | 6.4 | Amorphous 2 | Crystalline 2 | 1 | Cerium oxide | Titania | Silica |
| C-6 | C3 | P.B.15:1 | 6.6 | Amorphous 2 | Crystalline 2 | 1 | Cerium oxide | Titania | Silica |
| Comp. c-4 | Comp. c1 | P.B.25 | 6.5 | Amorphous 2 | Crystalline 2 | 1 | Cerium oxide | Titania | Silica |
| Comp. c-5 | Comp. c2 | P.B.56 | 6.5 | Amorphous 2 | Crystalline 2 | 1 | Cerium oxide | Titania | Silica |
| Comp. c-6 | Comp. c3 | P.B.61 | 6.5 | Amorphous 2 | Crystalline 2 | 1 | Cerium oxide | Titania | Silica |
| M-4 | M1 | P.R.122/238 | 6.4 | Amorphous 2 | Crystalline 2 | 1 | Cerium oxide | Titania | Silica |
| M-5 | M2 | P.R.122/P.R.238 | 6.5 | Amorphous 2 | Crystalline 2 | 1 | Cerium oxide | Titania | Silica |
| M-6 | M3 | P.R.122/P.R.238 | 6.4 | Amorphous 2 | Crystalline 2 | 1 | Cerium oxide | Titania | Silica |
| Comp. m-4 | Comp. m1 | P.R.122 | 6.5 | Amorphous 2 | Crystalline 2 | 1 | Cerium oxide | Titania | Silica |
| Comp. m-5 | Comp. m2 | P.R.122/P.R.245 | 6.6 | Amorphous 2 | Crystalline 2 | 1 | Cerium oxide | Titania | Silica |
| Comp. m-6 | Comp. m3 | P.R.122/P.R.253 | 6.4 | Amorphous 2 | Crystalline 2 | 1 | Cerium oxide | Titania | Silica |
| Y-2 | Y1 | P.Y.74 | 6.6 | Amorphous 2 | Crystalline 2 | 1 | Cerium oxide | Titania | Silica |
| Comp. y-4 | Comp. y1 | P.Y.39 | 6.3 | Amorphous 2 | Crystalline 2 | 1 | Cerium oxide | Titania | Silica |
| Comp. y-5 | Comp. y2 | P.Y.93 | 6.4 | Amorphous 2 | Crystalline 2 | 1 | Cerium oxide | Titania | Silica |
| Comp. y-6 | Comp. y3 | P.Y.181 | 6.4 | Amorphous 2 | Crystalline 2 | 1 | Cerium oxide | Titania | Silica |
| K-4 | K1 | CB/P.B.15:3 | 6.5 | Amorphous 2 | Crystalline 2 | 1 | Cerium oxide | Titania | Silica |
| K-5 | K2 | CB/P.B.15:2 | 6.4 | Amorphous 2 | Crystalline 2 | 1 | Cerium oxide | Titania | Silica |
| K-6 | K3 | CB/P.B.15:1 | 6.6 | Amorphous 2 | Crystalline 2 | 1 | Cerium oxide | Titania | Silica |
| Comp. k-2 | Comp. k1 | CB | 6.5 | Amorphous 2 | Crystalline 2 | 1 | Cerium oxide | Titania | Silica |

*1: Releasing Agent Dispersion No

(Preparation of Cyan Toners C-7 and C-9, Comparative Cyan Toners c-7 to c-9, Magenta Toners M-7 to M-9, Comparative Magenta Toners m-7 to m-9, Black Toners K-7 to K-9 and Comparative Black Toner k-3)

Cyan Toners C-7 and C-9, Comparative Cyan Toners c-7 to c-9, Magenta Toners M-7 to M-9, Comparative Magenta Toners m-7 to m-9, Black Toners K-7 to K-9 and Comparative Black Toner k-3 were prepared each in the same manner as in the preparation of Cyan Toners C-4 and C-6, Comparative Cyan Toners c-4 to c-6, Magenta Toners M-4 to M-6, Comparative Magenta Toners m-4 to m-6, Black Toners K-4 to K-6 and Comparative Black Toner k-2 respectively, except that the rapid cooling was changed to gradually cooling by 30° C. at a cooling rate of −1° C./minute. The volume-based median particle diameters of the toners are shown in Table 3.

TABLE 3

| Toner | Colorant | | D50 | Resin particle | Resin particle | | | | |
|---|---|---|---|---|---|---|---|---|---|
| Particle | Dispersion | Colorant | (μm) | dispersion (1) | dispersion (2) | *1 | External Additive | | |
| C-7 | C1 | P.B.15:3 | 6.4 | Amorphous 2 | Crystalline 2 | 1 | Cerium oxide | Titania | Silica |
| C-8 | C2 | P.B.15:2 | 6.4 | Amorphous 2 | Crystalline 2 | 1 | Cerium oxide | Titania | Silica |
| C-9 | C3 | P.B.15:1 | 6.6 | Amorphous 2 | Crystalline 2 | 1 | Cerium oxide | Titania | Silica |
| Comp. c-7 | Comp. c1 | P.B.25 | 6.5 | Amorphous 2 | Crystalline 2 | 1 | Cerium oxide | Titania | Silica |
| Comp. c-8 | Comp. c2 | P.B.56 | 6.6 | Amorphous 2 | Crystalline 2 | 1 | Cerium oxide | Titania | Silica |
| Comp. c-9 | Comp. c3 | P.B.61 | 6.4 | Amorphous 2 | Crystalline 2 | 1 | Cerium oxide | Titania | Silica |
| M-7 | M1 | P.R.122/238 | 6.5 | Amorphous 2 | Crystalline 2 | 1 | Cerium oxide | Titania | Silica |
| M-8 | M2 | P.R.122/P.R.238 | 6.6 | Amorphous 2 | Crystalline 2 | 1 | Cerium oxide | Titania | Silica |
| M-9 | M3 | P.R.122/P.R.238 | 6.4 | Amorphous 2 | Crystalline 2 | 1 | Cerium oxide | Titania | Silica |
| Comp. m-7 | Comp. m1 | P.R.122 | 6.7 | Amorphous 2 | Crystalline 2 | 1 | Cerium oxide | Titania | Silica |
| Comp. m-8 | Comp. m2 | P.R.122/P.R.245 | 6.6 | Amorphous 2 | Crystalline 2 | 1 | Cerium oxide | Titania | Silica |
| Comp. m-9 | Comp. m3 | P.R.122/P.R.253 | 6.7 | Amorphous 2 | Crystalline 2 | 1 | Cerium oxide | Titania | Silica |
| Y-2 | Y1 | P.Y.74 | 6.6 | Amorphous 2 | Crystalline 2 | 1 | Cerium oxide | Titania | Silica |
| Comp. y-7 | Comp. y1 | P.Y.39 | 6.7 | Amorphous 2 | Crystalline 2 | 1 | Cerium oxide | Titania | Silica |
| Comp. y-8 | Comp. y2 | P.Y.93 | 6.5 | Amorphous 2 | Crystalline 2 | 1 | Cerium oxide | Titania | Silica |
| Comp. y-9 | Comp. y3 | P.Y.181 | 6.6 | Amorphous 2 | Crystalline 2 | 1 | Cerium oxide | Titania | Silica |
| K-7 | K1 | CB/P.B.15:3 | 6.5 | Amorphous 2 | Crystalline 2 | 1 | Cerium oxide | Titania | Silica |
| K-8 | K2 | CB/P.B.15:2 | 6.4 | Amorphous 2 | Crystalline 2 | 1 | Cerium oxide | Titania | Silica |
| K-9 | K3 | CB/P.B.15:1 | 6.6 | Amorphous 2 | Crystalline 2 | 1 | Cerium oxide | Titania | Silica |
| Comp. k-3 | Comp. k1 | CB | 6.5 | Amorphous 2 | Crystalline 2 | 1 | Cerium oxide | Titania | Silica |

*1: Releasing Agent Dispersion No.

(Preparation of Cyan Toners C-10 and C-12, Comparative Cyan Toners c-10 to c-12, Magenta Toners M-10 to M-12, Comparative. Magenta Toners m-10 to m-12, Black Toners K-10 to K-12 and Comparative Black Toner k-4)

Cyan Toners C-10 and C-12, Comparative Cyan Toners c-10 to c-12, Magenta Toners M-10 to M-12, Comparative Magenta Toners m-10 to m-12, Black Toners K-10 to K-12 and Comparative Black Toner k-4 were each prepared in the same manner as in the preparation of Cyan Toners C-1 and C-3, Comparative Cyan Toners c-1 to c-3, Magenta Toners M-1 to M-3, Comparative Magenta Toners m-1 to m-3, Black Toners K-1 to K-3 and Comparative Black Toner k-1, respectively, except that the rapid cooling was changed to gradually cooling by 30° C. at a cooling rate of

−1° C./minute. The volume-based median particle diameters of the toners are shown in Table 4.

TABLE 4

| Toner | Colorant | | D50 | Resin particle | Resin particle | | | | |
|---|---|---|---|---|---|---|---|---|---|
| Particle | Dispersion | Colorant | (μm) | dispersion (1) | dispersion (2) | *1 | External Additive | | |
| C-10 | C1 | P.B.15:3 | 6.3 | Amorphous 1 | Crystalline 1 | 2 | Cerium oxide | Titania | Silica |
| C-11 | C2 | P.B.15:2 | 6.6 | Amorphous 1 | Crystalline 1 | 2 | Cerium oxide | Titania | Silica |
| C-12 | C3 | P.B.15:1 | 6.6 | Amorphous 1 | Crystalline 1 | 2 | Cerium oxide | Titania | Silica |
| Comp. c-10 | Comp. c1 | P.B.25 | 6.6 | Amorphous 1 | Crystalline 1 | 2 | Cerium oxide | Titania | Silica |
| Comp. c-11 | Comp. c2 | P.B.56 | 6.6 | Amorphous 1 | Crystalline 1 | 2 | Cerium oxide | Titania | Silica |
| Comp. c-12 | Comp. c3 | P.B.61 | 6.6 | Amorphous 1 | Crystalline 1 | 2 | Cerium oxide | Titania | Silica |
| M-10 | M1 | P.R.122/P.R.238 | 6.5 | Amorphous 1 | Crystalline 1 | 2 | Cerium oxide | Titania | Silica |
| M-11 | M2 | P.R.122/P.R.238 | 6.4 | Amorphous 1 | Crystalline 1 | 2 | Cerium oxide | Titania | Silica |
| M-12 | M3 | P.R.122/238 | 6.5 | Amorphous 1 | Crystalline 1 | 2 | Cerium oxide | Titania | Silica |
| Comp. m-10 | Comp. m1 | P.R.122 | 6.6 | Amorphous 1 | Crystalline 1 | 2 | Cerium oxide | Titania | Silica |
| Comp. m-11 | Comp. m2 | P.R.122/P.R.245 | 6.4 | Amorphous 1 | Crystalline 1 | 2 | Cerium oxide | Titania | Silica |
| Comp. m-12 | Comp. m3 | P.R.122/P.R.253 | 6.5 | Amorphous 1 | Crystalline 1 | 2 | Cerium oxide | Titania | Silica |
| Y-4 | Y1 | P.Y.74 | 6.5 | Amorphous 1 | Crystalline 1 | 2 | Cerium oxide | Titania | Silica |
| Comp. y-10 | Comp. y1 | P.Y.39 | 6.6 | Amorphous 1 | Crystalline 1 | 2 | Cerium oxide | Titania | Silica |
| Comp. y-11 | Comp. y2 | P.Y.93 | 6.4 | Amorphous 1 | Crystalline 1 | 2 | Cerium oxide | Titania | Silica |
| Comp. y-12 | Comp. y3 | P.Y.181 | 6.6 | Amorphous 1 | Crystalline 1 | 2 | Cerium oxide | Titania | Silica |
| K-10 | K1 | CB/P.B.15:3 | 6.5 | Amorphous 1 | Crystalline 1 | 2 | Cerium oxide | Titania | Silica |
| K-11 | K2 | CB/P.B.15:2 | 6.5 | Amorphous 1 | Crystalline 1 | 2 | Cerium oxide | Titania | Silica |
| K-12 | K3 | CB/P.B.15:1 | 6.6 | Amorphous 1 | Crystalline 1 | 2 | Cerium oxide | Titania | Silica |
| Comp. k-4 | Comp. k1 | CB | 6.6 | Amorphous 1 | Crystalline 1 | 2 | Cerium oxide | Titania | Silica |

*1: Releasing Agent Dispersion No.

(Preparation of Cyan Toners C-13 and C-15, Comparative Cyan Toners c-13 to c-15, Magenta Toners M-13 to M-15, Comparative Magenta Toners m-13 to m-15, Black Toners K-13 to K-15 and Comparative Black Toner k-5)

Cyan Toners C-13 and C-15, Comparative Cyan Toners c-13 to c-15, Magenta Toners M-13 to M-15, Comparative Magenta Toners m-13 to m-15, Black Toners K-13 to K-15 and Comparative Black Toner k-5 were each prepared in the same manner as in the preparation of Cyan Toners C-4 and C-6, Comparative Cyan Toners c-4 to c-6, Magenta Toners M-4 to M-6, Comparative Magenta Toners m-4 to m-6, Black Toners K-1 to K-3 and Comparative Black Toner k-2, respectively, except that the pH value of the dispersion was adjusted to 8.0 only by the aqueous solution of sodium hydroxide without addition of tetra sodium ethylenediaminetetraacetate tetrahydrate after the addition of 250 parts of Amorphous Polyester Resin Particle Dispersion 2. The volume-based median particle diameters of the toners are shown in Table 5.

TABLE 5

| Toner | Colorant | | D50 | Resin particle | Resin particle | | | | |
|---|---|---|---|---|---|---|---|---|---|
| Particle | Dispersion | Colorant | (μm) | dispersion (1) | dispersion (2) | *1 | External Additive | | |
| C-13 | C1 | P.B.15:3 | 6.3 | Amorphous 2 | Crystalline 2 | 1 | Cerium oxide | Titania | Silica |
| C-14 | C2 | P.B.15:2 | 6.6 | Amorphous 2 | Crystalline 2 | 1 | Cerium oxide | Titania | Silica |
| C-15 | C3 | P.B.15:1 | 6.6 | Amorphous 2 | Crystalline 2 | 1 | Cerium oxide | Titania | Silica |
| Comp. c-13 | Comp. c1 | P.B.25 | 6.6 | Amorphous 2 | Crystalline 2 | 1 | Cerium oxide | Titania | Silica |
| Comp. c-14 | Comp. c2 | P.B.56 | 6.6 | Amorphous 2 | Crystalline 2 | 1 | Cerium oxide | Titania | Silica |
| Comp. c-15 | Comp. c3 | P.B.61 | 6.6 | Amorphous 2 | Crystalline 2 | 1 | Cerium oxide | Titania | Silica |
| M-13 | M1 | P.R.122/P.R.238 | 6.5 | Amorphous 2 | Crystalline 2 | 1 | Cerium oxide | Titania | Silica |
| M-14 | M2 | P.R.122/P.R.238 | 6.4 | Amorphous 2 | Crystalline 2 | 1 | Cerium oxide | Titania | Silica |
| M-15 | M3 | P.R.122/P.R.238 | 6.5 | Amorphous 2 | Crystalline 2 | 1 | Cerium oxide | Titania | Silica |
| Comp. m-13 | Comp. m1 | P.R.122 | 6.6 | Amorphous 2 | Crystalline 2 | 1 | Cerium oxide | Titania | Silica |
| Comp. m-14 | Comp. m2 | P.R.122/P.R.245 | 6.4 | Amorphous 2 | Crystalline 2 | 1 | Cerium oxide | Titania | Silica |
| Comp. m-15 | Comp. m3 | P.R.122/253 | 6.5 | Amorphous 2 | Crystalline 2 | 1 | Cerium oxide | Titania | Silica |
| Y-5 | Y1 | P.Y.74 | 6.5 | Amorphous 2 | Crystalline 2 | 1 | Cerium oxide | Titania | Silica |
| Comp. y-13 | Comp. y1 | P.Y.39 | 6.6 | Amorphous 2 | Crystalline 2 | 1 | Cerium oxide | Titania | Silica |
| Comp. y-14 | Comp. y2 | P.Y.93 | 6.4 | Amorphous 2 | Crystalline 2 | 1 | Cerium oxide | Titania | Silica |
| Comp. y-15 | Comp. y3 | P.Y.181 | 6.6 | Amorphous 2 | Crystalline 2 | 1 | Cerium oxide | Titania | Silica |
| K-13 | K1 | CB/P.B.15:3 | 6.5 | Amorphous 2 | Crystalline 2 | 1 | Cerium oxide | Titania | Silica |
| K-14 | K2 | CB/P.B.15:2 | 6.5 | Amorphous 2 | Crystalline 2 | 1 | Cerium oxide | Titania | Silica |
| K-15 | K3 | CB/P.B.15:1 | 6.6 | Amorphous 2 | Crystalline 2 | 1 | Cerium oxide | Titania | Silica |
| Comp. k-5 | Comp. k1 | CB | 6.6 | Amorphous 2 | Crystalline 2 | 1 | Cerium oxide | Titania | Silica |

*1: Releasing Agent Dispersion No.

(Preparation of Comparative Cyan Toners c-16 to c-21, Comparative Magenta Toners m-16 to m-21, Comparative Yellow Toners y-16 to y-19 and Comparative Toners k-6 to k-9)

Comparative Cyan Toners c-16 to c-21, Comparative Magenta Toners m-16 to m-21, Comparative Yellow Toners y-16 to y-19 and Comparative Toners k-6 to k-9 were each prepared in the same manner as in Cyan Toners C-1 and C-3, Comparative Cyan Toners c-1 to c-3, Magenta Toners M-1 to M-3, Comparative Magenta Toners m-1 to m-3, Black Toners K-1 to K-3 and Comparative Black Toner k-1, respectively, except that cerium oxide particle was omitted. The volume-based median particle diameters of the toners are shown in Table 6.

TABLE 6

| | | | | | | Releasing | | | |
|---|---|---|---|---|---|---|---|---|---|
| | | | | | | Agent | | | |
| Toner | Colorant | | D50 | Resin particle | Resin particle | Dispersion | | | |
| Particle | Dispersion | Colorant | (μm) | dispersion (1) | dispersion (2) | No. | External Additive | | |
| Comp. c-16 | C1 | P.B.15:3 | 6.5 | Amorphous 1 | Crystalline 1 | 2 | — | Titania | Silica |
| Comp. c-17 | C2 | P.B.15:2 | 6.6 | Amorphous 1 | Crystalline 1 | 2 | — | Titania | Silica |
| Comp. c-18 | C3 | P.B.15:1 | 6.5 | Amorphous 1 | Crystalline 1 | 2 | — | Titania | Silica |
| Comp. c-19 | Comp. c1 | P.B.25 | 6.4 | Amorphous 1 | Crystalline 1 | 2 | — | Titania | Silica |
| Comp. c-20 | Comp. c2 | P.B.56 | 6.6 | Amorphous 1 | Crystalline 1 | 2 | — | Titania | Silica |
| Comp. c-21 | Comp. c3 | P.B.61 | 6.5 | Amorphous 1 | Crystalline 1 | 2 | — | Titania | Silica |
| Comp. m-16 | M1 | P.R.122/238 | 6.5 | Amorphous 1 | Crystalline 1 | 2 | — | Titania | Silica |
| Comp. m-17 | M2 | P.R.122/P.R.238 | 6.3 | Amorphous 1 | Crystalline 1 | 2 | — | Titania | Silica |
| Comp. m-18 | M3 | P.R.122/P.R.238 | 6.5 | Amorphous 1 | Crystalline 1 | 2 | — | Titania | Silica |
| Comp. m-19 | Comp. m1 | P.R.122 | 6.6 | Amorphous 1 | Crystalline 1 | 2 | — | Titania | Silica |
| Comp. m-20 | Comp. m2 | P.R.122/P.R.245 | 6.6 | Amorphous 1 | Crystalline 1 | 2 | — | Titania | Silica |
| Comp. m-21 | Comp. m3 | P.R.122/253 | 6.5 | Amorphous 1 | Crystalline 1 | 2 | — | Titania | Silica |
| Comp. y-16 | Y1 | P.Y.74 | 6.5 | Amorphous 1 | Crystalline 1 | 2 | — | Titania | Silica |
| Comp. y-17 | Comp. y1 | P.Y.39 | 6.4 | Amorphous 1 | Crystalline 1 | 2 | — | Titania | Silica |
| Comp. y-18 | Comp. y2 | P.Y.93 | 6.4 | Amorphous 1 | Crystalline 1 | 2 | — | Titania | Silica |
| Comp. y-19 | Comp. y3 | P.Y.181 | 6.5 | Amorphous 1 | Crystalline 1 | 2 | — | Titania | Silica |
| Comp. k-6 | K1 | CB/P.B.15:3 | 6.5 | Amorphous 1 | Crystalline 1 | 2 | — | Titania | Silica |
| Comp. k-7 | K2 | CB/P.B.15:2 | 6.3 | Amorphous 1 | Crystalline 1 | 2 | — | Titania | Silica |
| Comp. k-8 | K3 | CB/P.B.15:1 | 6.5 | Amorphous 1 | Crystalline 1 | 2 | — | Titania | Silica |
| Comp. k-9 | Comp. k1 | CB | 6.4 | Amorphous 1 | Crystalline 1 | 2 | — | Titania | Silica |

(Preparation of Comparative Cyan Toners c-22 to c-27, Comparative Magenta Toners m-22 to m-27, Comparative Yellow Toners y-20 to y-23 and Comparative Toners k-10 to k-13)

Comparative Cyan Toners c-22 to c-27, Comparative Magenta Toners m-22 to m-27, Comparative Yellow Toners y-20 to y-23 and Comparative Toners k-10 to k-13 were each prepared in the same manner as in Cyan toners C-4 to C-6, Comparative Cyan Toners c-4 to c-6, Magenta Toners M-4 to M-6, Comparative Magenta Toners m-4 to m-6, Black Toners K-4 to and Comparative Toner k-2, respectively, except that 200 parts of Crystalline Polyester Resin Particle Dispersion was replaced by 200 parts of Amorphous polyester resin particle Dispersion 2. The volume-based median particle diameters of the toners are shown in Table 7.

TABLE 7

| Toner | Colorant | | D50 | Resin particle | Resin particle | | | | |
|---|---|---|---|---|---|---|---|---|---|
| Particle | Dispersion | Colorant | (μm) | dispersion (1) | dispersion (2) | *1 | External Additive | | |
| Comp. c-22 | C1 | P.B.15:3 | 6.6 | Amorphous 2 | Amorphous 2 | 1 | Cerium oxide | Titania | Silica |
| Comp. c-23 | C2 | P.B.15:2 | 6.4 | Amorphous 2 | Amorphous 2 | 1 | Cerium oxide | Titania | Silica |
| Comp. c-24 | C3 | P.B.15:1 | 6.6 | Amorphous 2 | Amorphous 2 | 1 | Cerium oxide | Titania | Silica |
| Comp. c-25 | Comp. c1 | P.B.25 | 6.5 | Amorphous 2 | Amorphous 2 | 1 | Cerium oxide | Titania | Silica |
| Comp. c-26 | Comp. c2 | P.B.56 | 6.5 | Amorphous 2 | Amorphous 2 | 1 | Cerium oxide | Titania | Silica |
| Comp. c-27 | Comp. c3 | P.B.61 | 6.5 | Amorphous 2 | Amorphous 2 | 1 | Cerium oxide | Titania | Silica |
| Comp. m-22 | M1 | P.R.122/P.R.238 | 6.4 | Amorphous 2 | Amorphous 2 | 1 | Cerium oxide | Titania | Silica |
| Comp. m-23 | M2 | P.R.122/P.R.238 | 6.5 | Amorphous 2 | Amorphous 2 | 1 | Cerium oxide | Titania | Silica |
| Comp. m-24 | M3 | P.R.122/P.R.238 | 6.4 | Amorphous 2 | Amorphous 2 | 1 | Cerium oxide | Titania | Silica |
| Comp. m-25 | Comp. m1 | P.R.122 | 6.5 | Amorphous 2 | Amorphous 2 | 1 | Cerium oxide | Titania | Silica |
| Comp. m-26 | Comp. m2 | P.R.122/P.R.245 | 6.6 | Amorphous 2 | Amorphous 2 | 1 | Cerium oxide | Titania | Silica |
| Comp. m-27 | Comp. m3 | P.R.122/P.R.253 | 6.4 | Amorphous 2 | Amorphous 2 | 1 | Cerium oxide | Titania | Silica |
| Comp. y-20 | Y1 | P.Y.74 | 6.6 | Amorphous 2 | Amorphous 2 | 1 | Cerium oxide | Titania | Silica |
| Comp. y-21 | Comp. y1 | P.Y.39 | 6.3 | Amorphous 2 | Amorphous 2 | 1 | Cerium oxide | Titania | Silica |
| Comp. y-22 | Comp. y2 | P.Y.93 | 6.4 | Amorphous 2 | Amorphous 2 | 1 | Cerium oxide | Titania | Silica |
| Comp. y-23 | Comp. y3 | P.Y.181 | 6.4 | Amorphous 2 | Amorphous 2 | 1 | Cerium oxide | Titania | Silica |
| Comp. k-10 | K1 | CB/P.B.15:3 | 6.5 | Amorphous 2 | Amorphous 2 | 1 | Cerium oxide | Titania | Silica |
| Comp. k-11 | K2 | CB/P.B.15:2 | 6.4 | Amorphous 2 | Amorphous 2 | 1 | Cerium oxide | Titania | Silica |
| Comp. k-12 | K3 | CB/P.B.15:1 | 6.6 | Amorphous 2 | Amorphous 2 | 1 | Cerium oxide | Titania | Silica |
| Comp. k-13 | Comp. k1 | CB | 6.5 | Amorphous 2 | Amorphous 2 | 1 | Cerium oxide | Titania | Silica |

*1: Releasing Agent Dispersion No.

To ferrite core having a particle diameter of 35 μm, 0.8% by weight of silicone resin SR2411, manufactured by Toray Dawn Corning Corp., was added and coated by a flowing bed coating machine to obtain a carrier for preparing developer.

Seven parts of each of the above toners was mixed with parts of the carrier by a V-type blender.

### (Preparation of Developer Set)

Two-component Developer Sets 1 to 102 were prepared by combining each of Yellow, magenta, cyan and black two-component developers as shown in Table 8 (1) to 8 (7).

TABLE 8 (1)

| Developer | Cyan | Magenta | Yellow | Black |
|---|---|---|---|---|
| set No. | toner | toner | toner | toner |
| 1 | C-1 | M-1 | Y-1 | K-1 |
| 2 | C-1 | M-2 | Y-1 | K-1 |
| 3 | C-1 | M-3 | Y-1 | K-1 |
| 4 | C-1 | M-1 | Y-1 | K-2 |
| 5 | C-1 | M-1 | Y-1 | K-3 |
| 6 | Comp. c-1 | M-1 | Y-1 | K-1 |
| 7 | Comp. c-2 | M-1 | Y-1 | K-1 |
| 8 | Comp. c-3 | M-1 | Y-1 | K-1 |
| 9 | C-1 | Comp. m-1 | Y-1 | K-1 |
| 10 | C-1 | Comp. m-2 | Y-1 | K-1 |
| 11 | C-1 | Comp. m-3 | Y-1 | K-1 |
| 12 | C-2 | M-1 | Y-1 | K-1 |
| 13 | C-1 | M-1 | Comp. y1 | K-1 |
| 14 | C-1 | M-1 | Comp. y2 | K-1 |
| 15 | C-1 | M-1 | Comp. y3 | K-1 |
| 16 | C-1 | M-1 | Y-1 | Comp. k-11 |
| 17 | C-2 | M-2 | Y-1 | K-2 |
| 18 | C-3 | M-3 | Y-1 | K-3 |

TABLE 8 (2)

| Developer | Cyan | Magenta | Yellow | Black |
|---|---|---|---|---|
| set No. | toner | toner | toner | toner |
| 19 | C-4 | M-4 | Y-2 | K-4 |
| 20 | C-4 | M-5 | Y-2 | K-4 |
| 21 | C-4 | M-6 | Y-2 | K-4 |
| 22 | C-4 | M-4 | Y-2 | K-5 |
| 23 | C-4 | M-4 | Y-2 | K-6 |
| 24 | Comp. c-4 | M-4 | Y-2 | K-4 |
| 25 | Comp. c-5 | M-4 | Y-2 | K-4 |
| 26 | Comp. c-6 | M-4 | Y-2 | K-4 |
| 27 | C-4 | Comp. m-4 | Y-2 | K-4 |
| 28 | C-4 | Comp. m-5 | Y-2 | K-4 |
| 29 | C-4 | Comp. m-6 | Y-2 | K-4 |
| 30 | C-5 | M-4 | Y-2 | K-4 |
| 31 | C-4 | M-4 | Comp. y4 | K-4 |
| 32 | C-4 | M-4 | Comp. y5 | K-4 |
| 33 | C-4 | M-4 | Comp. y6 | K-4 |
| 34 | C-4 | M-4 | Y-2 | Comp. k-2 |
| 35 | C-5 | M-5 | Y-2 | K-5 |
| 36 | C-6 | M-6 | Y-2 | K-6 |

TABLE 8 (3)

| Developer | Cyan | Magenta | Yellow | Black |
|---|---|---|---|---|
| set No. | toner | toner | toner | toner |
| 37 | C-7 | M-7 | Y-3 | K-7 |
| 38 | C-7 | M-8 | Y-3 | K-7 |
| 39 | C-7 | M-9 | Y-3 | K-7 |
| 40 | C-7 | M-7 | Y-3 | K-8 |
| 41 | C-7 | M-7 | Y-3 | K-9 |
| 42 | Comp. c-7 | M-7 | Y-3 | K-7 |
| 43 | Comp. c-8 | M-7 | Y-3 | K-7 |
| 44 | Comp. c-9 | M-7 | Y-3 | K-7 |
| 45 | C-7 | Comp. m-7 | Y-3 | K-7 |
| 46 | C-7 | Comp. m-8 | Y-3 | K-7 |
| 47 | C-7 | Comp. m-9 | Y-3 | K-7 |
| 48 | C-8 | M-7 | Y-3 | K-7 |
| 49 | C-7 | M-7 | Comp. y7 | K-7 |
| 50 | C-7 | M-7 | Comp. y8 | K-7 |
| 51 | C-7 | M-7 | Comp. y9 | K-7 |
| 52 | C-7 | M-7 | Y-3 | Comp. k-3 |
| 53 | C-8 | M-8 | Y-3 | K-8 |
| 54 | C-9 | M-9 | Y-3 | K-9 |

TABLE 8 (4)

| Developer | Cyan | Magenta | Yellow | Black |
|---|---|---|---|---|
| set No. | toner | toner | toner | toner |
| 55 | C-10 | M-10 | Y-4 | K-10 |
| 56 | C-10 | M-11 | Y-4 | K-10 |
| 57 | C-10 | M-12 | Y-4 | K-10 |
| 58 | C-10 | M-10 | Y-4 | K-11 |
| 59 | C-10 | M-10 | Y-4 | K-12 |
| 60 | Comp. c-10 | M-10 | Y-4 | K-10 |
| 61 | Comp. c-11 | M-10 | Y-4 | K-10 |
| 62 | Comp. c-12 | M-10 | Y-4 | K-10 |
| 63 | C-10 | Comp. m-10 | Y-4 | K-10 |
| 64 | C-10 | Comp. m-11 | Y-4 | K-10 |
| 65 | C-10 | Comp. m-12 | Y-4 | K-10 |
| 66 | C-11 | M-10 | Y-4 | K-10 |
| 67 | C-10 | M-10 | Comp. y10 | K-10 |
| 68 | C-10 | M-10 | Comp. y11 | K-10 |
| 69 | C-10 | M-10 | Comp. y12 | K-10 |
| 70 | C-10 | M-10 | Y-4 | Comp. k-4 |
| 71 | C-11 | M-11 | Y-4 | K-11 |
| 72 | C-12 | M-12 | Y-4 | K-12 |

TABLE 8 (5)

| Developer | Cyan | Magenta | Yellow | Black |
|---|---|---|---|---|
| set No. | toner | toner | toner | toner |
| 73 | C-13 | M-13 | Y-5 | K-13 |
| 74 | C-13 | M-14 | Y-5 | K-13 |
| 75 | C-13 | M-15 | Y-5 | K-13 |
| 76 | C-13 | M-13 | Y-5 | K-14 |
| 77 | C-13 | M-13 | Y-5 | K-15 |
| 78 | Comp. c-13 | M-13 | Y-5 | K-13 |
| 79 | Comp. c-14 | M-13 | Y-5 | K-13 |
| 80 | Comp. c-15 | M-13 | Y-5 | K-13 |
| 81 | C-13 | Comp. m-13 | Y-5 | K-13 |
| 82 | C-13 | Comp. m-14 | Y-5 | K-13 |
| 83 | C-13 | Comp. m-15 | Y-5 | K-13 |
| 84 | C-14 | M-13 | Y-5 | K-13 |
| 85 | C-13 | M-13 | Comp. y13 | K-13 |
| 86 | C-13 | M-13 | Comp. y14 | K-13 |
| 87 | C-13 | M-13 | Comp. y15 | K-13 |
| 88 | C-13 | M-13 | Y-5 | Comp. k-5 |
| 89 | C-14 | M-14 | Y-5 | K-14 |
| 90 | C-15 | M-15 | Y-5 | K-15 |

TABLE 8 (6)

| Developer | Cyan | Magenta | Yellow | Black |
|---|---|---|---|---|
| set No. | toner | toner | toner | toner |
| 91 | Comp. c-16 | Comp. m-16 | Comp. y-16 | Comp. k-6 |
| 92 | Comp. c-17 | Comp. m-17 | Comp. y-16 | Comp. k-6 |
| 93 | Comp. c-18 | Comp. m-18 | Comp. y-16 | Comp. k-6 |
| 94 | Comp. c-19 | Comp. m-19 | Comp. y-17 | Comp. k-7 |
| 95 | Comp. c-20 | Comp. m-20 | Comp. y-18 | Comp. k-8 |
| 96 | Comp. c-21 | Comp. m-21 | Comp. y-19 | Comp. k-9 |

TABLE 8 (7)

| Developer | Cyan | Magenta | Yellow | Black |
|---|---|---|---|---|
| set No. | toner | toner | toner | toner |
| 97 | Comp. c-22 | Comp. m-22 | Comp. y-22 | Comp. k-10 |
| 98 | Comp. c-23 | Comp. m-23 | Comp. y-22 | Comp. k-10 |
| 99 | Comp. c-24 | Comp. m-24 | Comp. y-22 | Comp. k-10 |
| 100 | Comp. c-25 | Comp. m-25 | Comp. y-23 | Comp. k-11 |
| 101 | Comp. c-26 | Comp. m-26 | Comp. y-24 | Comp. k-12 |
| 102 | Comp. c-27 | Comp. m-27 | Comp. y-25 | Comp. k-13 |

### 3. Evaluation Test

Each of the developer sets composed of yellow, magenta, cyan and black developers shown in Table 8 was charged in an image forming apparatus and subjected to the following evaluation tests.

### (Evaluation of Fixing Ability)

A full-color printer available on the market bizhub Pro C500, manufactured by Konica Minolta Business Technologies Inc., corresponding to FIG. 1 was used, and the processing speed was set at 14 mm/sec and the fixing temperature was varied from 80 to 180° C. for testing the fixing ability. The evaluation was carried out according to the lowest fixing temperature at which offset did, not occur. Test results were ranked according to the following norms. Ranks A, B and C were judged as acceptable.

Rank A: The lowest fixing temperature was less than 100° C.

Rank B: The lowest fixing temperature was not less than 100° C. and less than 110° C.

Rank C: The lowest fixing temperature was not less than 110° C. and less than 120° C.

Rank D: The lowest fixing temperature was not less than 120° C. and less than 130° C.

Rank E: The lowest fixing temperature was not less than 130° C.

Among the developer sets listed in Table 8, the sets composed of the developers having the constitution of the invention were within the ranks A to C and it was confirmed that suitable fixing ability can be obtained.

### (Transfer Efficiency)

The transfer efficiency under the condition of 30° C. and 90% RH was evaluated by using a full-color printer available on the market bizhub Pro C500, manufactured by Konica Minolta Business Technologies Inc., corresponding to FIG. 1 having a brush cleaner.

The evaluation was carried out as follows: The sets of the yellow, magenta, cyan and black developer shown in Table 8 were set in the above printer and stood for 72 hours under the environment of a temperature of 30° C. and a relative humidity of 90%. After that, the developing condition was set so as to make the toner developing amount of each color on the photoreceptor surface to 4.5 g/m² on the occasion of the evaluation.

The transfer efficiency was calculated according to the ratio of the amount recovered toner to the total amount of used toner. Namely, the consumed amount of toner “a” by the examination was determined by the variation of the weight of toner cartridge before and after the examination and the amount of recovered toner “b” was determined by the variation of the weight of the used toner recovering box before and after the examination. The transfer efficiency η was calculated by the following expression.

Transfer efficiency η=(a−b)/a×100

Objective transfer efficiency was not less than 90%. The valuation was carried out according to the following norms and the samples showing the value of 90% or more are judged as acceptable for practical use.

Among the developer sets listed in Table 8, the sets composed of developers having the constitution of the invention all had the transfer efficiency of not less than 90% and many of them shown the transfer efficiency of from 95 to 98% or not less than 98%, and it was confirmed that these sets had suitable transfer efficiency.

<Evaluation of Anti-Filming Ability on Intermediate Transfer Members>

Continuous printing test was carried out under conditions of 33° C. and 81% RH by using the full-color printer available on the market bizhub Pro C500, manufactured by Konica Minolta Business Technologies Inc., corresponding to FIG. 1. The intermediate transfer member on which the toners of the invention were used was visually observed and the anti-filming ability was evaluated according to the total print number until the white line caused by filming could be detected. Samples ranked into Rank A or B were, judged as acceptable.

Rank A: Filming was not caused at all until 1,200,000 prints.

Rank B: No stain was caused until 800,000 prints and no image defect was detected even though slight filming was caused on the intermediate transfer member.

Rank C: Image defect was detected before 800,000 prints.

### (1) Evaluation of Halftone Image (Graininess, Uniformity)

Japan Imaging Society Test Chart No. 3, Sample No. 5-1 (Continuous color portrait and color gradation patch), published by the 1st section of the Japan Imaging Society, was printed by the full-color printer available on the market bizhub Pro C500, manufactured by Konica Minolta Business Technologies Inc., corresponding to FIG. 1 and the printed images were visually evaluated. The dampish expression in a flower image and the skin color of portrait were noted in the evaluation. Evaluation results were ranked according to the following norms and the samples of Ranks A and B were judged as acceptable.

(Evaluation Norms)

Rank A: Any graininess was not felt at all in the visual observation, and any toner particle causing toner dots near characters was not by the observation using a loupe with a magnitude of 20 times.

Rank B: Slight graininess was felt by closely visual observation, or one to three toner particles causing toner dots near characters were observed between the dots by the observation using the loupe with a magnitude of 20 times.

Rank C: Roughness higher than Rank B was visually observed, or difficultly countable toner particles causing toner dots near characters were observed between the dots by the observation using the loupe with a magnitude of 20 times.

### (2) Evaluation of Graininess of Soft Tone Image

Soft tone images were evaluated in the same manner as in the above halftone image evaluation. The soft tone is colors classified as color expressing calm and gentle atmosphere which is formed by slightly darkening clear colors.

Patch images of 8 soft tone colors of #cc6666, #9966, #cccc66, #99 cc66, #66 cc66, #66 cc99, #66 cccc and #6699 cc from Web Safe Color were printed in the printer mode and the graininess of each of the images was comprehensively evaluated according to the following norms. Samples classified in Ranks A to C were judged as acceptable.

(Evaluation Norms)

Rank A: It was confirmed that halftone images having fine graininess and high uniformity were reproduced as to all patch images by observation using a loupe with a magnitude of 10.

Rank B: No problem was found in all patch images by the visual observation but some images roughened in some degree were found by the observation using the loupe with a magnitude of 10.

Rank C: Patch images on which roughened graininess in some degree were confirmed but the images were judged as acceptable.

Rank D: Roughening in the images was visually confirmed and some images were looked as roughened.

Conditions of computer display for displaying the above soft tone image were as follows:

iMac (Apple Computer Co., Ltd.),

24-inch wide screen LCD,

Resolution: 1,920×1,200 pixels,

2.16 GHz Intel Core 2 Duo Processor 1,

4 MB shared secondary cash,

1 GB memory (2×512 MB S0-DIMM,

250 GB serial ATA hard drive,

8× double layer system Super Drive (DVD+R DL, DVD±RW, CD-RW),

NVIDIA GEFORCE 7300 GT 128 MG GDDR memory,

Air Mac Extreme, and built-in Bluetooth 2, and

Apple Remote

### (3) Evaluation of Graininess of Dull Tone Image

The graininess of was evaluated by using the following dull tone images. The dull tone is colors classified as color with slight darkness formed by adding a slight amount of black to clear color for expressing calm and a little complex expression.

Patch images of 6 dull tone colors of #996666, #999966, #669966, #669999, #666699 and #996699 from Web Safe Color were printed in the printer mode and the graininess of each of the images was comprehensively evaluated according to the same norms as in the evaluation of the soft tone images. Samples ranked as Ranks A to C were judged as acceptable. The conditions of computer display for displaying the patch images of 6 dull colors were the same as that for displayer the above soft tone color patches.

### (4) Evaluation of Color Reproducibility of Greenish Color Code

Patch images of eight greenish color codes were output on the computer display and prints corresponding to the patch images were prepared. It was judged that how many colors could be discriminated.

The codes of the greenish eight colors were as follows: Yellow Green (#9ACD32), Green Yellow (#ADFF2F), Chartreuse (#7FF00), Lime (#00FF00), Spring Green (#00FF7F), Medium Spring-Green-(#00FA9A), Lime Green (#32CD32) and Medium Sea Green (#3CB371). The evaluation was carried out as follow and Ranks A and B were judged as acceptable.

(Evaluation Norms)

Rank A: The eight colors could be all discriminated (Excellent).

Rank B: Not less than six and less than eight colors could be discriminated (Good).

Rank C: Only six colors could be discriminated (Poor).

### (5) Evaluation of Color Reproducibility of Dark Bluish Color Code

Patch images of ten dark bluish color codes were output on the computer display and prints corresponding to the patch images were prepared. It was judged that how many colors could be discriminated.

The ten color codes of the bluish purple colors were as follows: #0077ff, #006fef, #0068e0, #0061d1, #005ac1, 0053b2, #004ca3, #004593, #003d84 and #003675. The evaluation was carried out as follow and Ranks A and B were judged as acceptable.

### (Evaluation Norms)

Rank A: The seven or more colors could be discriminated.

Rank B: Not less than five and less than seven colors could be discriminated.

Rank C: Only less than four colors could be discriminated.

The results are summarized in Tables 9 (1) to 9 (7).

TABLE 9 (1)

| | | | | Halftone | Graininess | | Color reproduction | |
|---|---|---|---|---|---|---|---|---|
| | | Transfer | | image | soft | dull | greenish | dark |
| Developer | Fixing | efficiency | | (Graininess, | tone | tone | color | bluish |
| set No. | ability | (%) | Anti-filming ability | uniformity) | image | image | code | color code |
| 1 | 95° C. | 98 | Not observed up to | A | A | A | 7 colors | 10 colors |
| | | | 1200 thousandth sheet | | | | | |
| 2 | 95° C. | 99 | Not observed up to | A | A | A | 7 colors | 10 colors |
| | | | 1200 thousandth sheet | | | | | |
| 3 | 95° C. | 98 | Not observed up to | A | A | A | 7 colors | 10 colors |
| | | | 1200 thousandth sheet | | | | | |
| 4 | 95° C. | 98 | Not observed up to | A | A | B | 7 colors | 10 colors |
| | | | 1200 thousandth sheet | | | | | |
| 5 | 95° C. | 97 | Not observed up to | A | B | A | 7 colors | 10 colors |
| | | | 1200 thousandth sheet | | | | | |
| 6 | 95° C. | 94 | 1100 thousandth sheet | D | D | D | 5 colors | 5 colors |
| 7 | 95° C. | 92 | 1100 thousandth sheet | D | C | D | 5 colors | 6 colors |
| 8 | 95° C. | 93 | 1100 thousandth sheet | D | D | D | 5 colors | 5 colors |
| 9 | 95° C. | 90 | 1100 thousandth sheet | A | C | A | 7 colors | 6 colors |
| 10 | 95° C. | 91 | 1100 thousandth sheet | A | C | B | 7 colors | 6 colors |
| 11 | 95° C. | 90 | 1100 thousandth sheet | A | C | B | 7 colors | 6 colors |
| 12 | 95° C. | 96 | 1100 thousandth sheet | A | A | B | 5 colors | 9 colors |
| 13 | 95° C. | 94 | 800 thousandth sheet | B | B | B | 4 colors | 10 colors |
| 14 | 95° C. | 95 | 700 thousandth sheet | B | B | B | 4 colors | 10 colors |
| 15 | 95° C. | 94 | 500 thousandth sheet | B | B | B | 7 colors | 10 colors |
| 16 | 100° C. | 79 | 1100 thousandth sheet | D | D | D | 7 colors | 5 colors |
| 17 | 95° C. | 96 | Not observed up to | B | A | B | 7 colors | 9 colors |
| | | | 1200 thousandth sheet | | | | | |
| 18 | 95° C. | 95 | Not observed up to | B | B | A | 7 colors | 9 colors |
| | | | 1200 thousandth sheet | | | | | |

TABLE 9 (2)

| | | | | Halftone | Graininess | | Color reproduction | |
|---|---|---|---|---|---|---|---|---|
| | | Transfer | | image | soft | dull | greenish | dark |
| Developer | Fixing | efficiency | | (Graininess, | tone | tone | color | bluish |
| set No. | ability | (%) | Anti-filming ability | uniformity) | image | image | code | color code |
| 19 | 90° C. | 97 | 900 thousandth sheet | A | A | A | 7 colors | 10 colors |
| 20 | 90° C. | 98 | 900 thousandth sheet | A | A | A | 7 colors | 10 colors |
| 21 | 90° C. | 98 | 900 thousandth sheet | A | A | A | 7 colors | 10 colors |
| 22 | 90° C. | 98 | 900 thousandth sheet | A | A | B | 7 colors | 9 colors |
| 23 | 90° C. | 99 | 900 thousandth sheet | A | B | A | 7 colors | 9 colors |
| 24 | 90° C. | 92 | 900 thousandth sheet | D | D | D | 5 colors | 6 colors |
| 25 | 90° C. | 91 | 900 thousandth sheet | D | C | D | 5 colors | 6 colors |
| 26 | 90° C. | 93 | 900 thousandth sheet | D | D | D | 5 colors | 6 colors |
| 27 | 90° C. | 90 | 900 thousandth sheet | A | C | A | 7 colors | 6 colors |
| 28 | 90° C. | 93 | 900 thousandth sheet | A | C | B | 7 colors | 6 colors |
| 29 | 90° C. | 90 | 900 thousandth sheet | A | C | B | 7 colors | 6 colors |
| 30 | 90° C. | 96 | 900 thousandth sheet | A | A | B | 5 colors | 9 colors |
| 31 | 90° C. | 90 | 700 thousandth sheet | B | B | B | 4 colors | 9 colors |
| 32 | 90° C. | 90 | 700 thousandth sheet | B | B | B | 4 colors | 9 colors |
| 33 | 90° C. | 94 | 500 thousandth sheet | B | B | B | 7 colors | 9 colors |
| 34 | 95° C. | 74 | 900 thousandth sheet | D | D | D | 7 colors | 5 colors |
| 35 | 90° C. | 95 | 900 thousandth sheet | B | A | B | 7 colors | 9 colors |
| 36 | 90° C. | 95 | 900 thousandth sheet | B | B | A | 7 colors | 9 colors |

TABLE 9 (3)

| | | | | Halftone | Graininess | | Color reproduction | |
|---|---|---|---|---|---|---|---|---|
| | | Transfer | | image | soft | dull | greenish | dark |
| Developer | Fixing | efficiency | | (Graininess, | tone | tone | color | bluish |
| set No. | ability | (%) | Anti-filming ability | uniformity) | image | image | code | color code |
| 37 | 90° C. | 96 | 850 thousandth sheet | A | A | A | 7 colors | 10 colors |
| 38 | 90° C. | 97 | 850 thousandth sheet | A | A | A | 7 colors | 10 colors |
| 39 | 90° C. | 98 | 850 thousandth sheet | A | A | A | 7 colors | 10 colors |
| 40 | 90° C. | 97 | 850 thousandth sheet | A | A | B | 7 colors | 9 colors |
| 41 | 90° C. | 98 | 850 thousandth sheet | A | B | A | 7 colors | 9 colors |
| 42 | 90° C. | 93 | 850 thousandth sheet | D | C | D | 5 colors | 6 colors |
| 43 | 90° C. | 91 | 850 thousandth sheet | D | D | D | 5 colors | 6 colors |
| 44 | 90° C. | 90 | 850 thousandth sheet | C | D | C | 5 colors | 6 colors |
| 45 | 90° C. | 91 | 850 thousandth sheet | B | C | B | 7 colors | 6 colors |
| 46 | 90° C. | 90 | 850 thousandth sheet | B | C | B | 7 colors | 6 colors |
| 47 | 90° C. | 91 | 850 thousandth sheet | B | C | B | 7 colors | 6 colors |
| 48 | 90° C. | 96 | 850 thousandth sheet | A | A | B | 5 colors | 9 colors |
| 49 | 90° C. | 91 | 850 thousandth sheet | B | B | B | 4 colors | 9 colors |
| 50 | 90° C. | 90 | 850 thousandth sheet | B | B | B | 4 colors | 9 colors |
| 51 | 90° C. | 91 | 850 thousandth sheet | B | B | B | 7 colors | 9 colors |
| 52 | 90° C. | 74 | 850 thousandth sheet | C | D | D | 7 colors | 5 colors |
| 53 | 90° C. | 95 | 850 thousandth sheet | B | A | B | 7 colors | 9 colors |
| 54 | 90° C. | 96 | 850 thousandth sheet | A | B | A | 7 colors | 9 colors |

TABLE 9 (4)

| | | | | Halftone | Graininess | | Color reproduction | |
|---|---|---|---|---|---|---|---|---|
| | | Transfer | | image | soft | dull | greenish | dark |
| Developer | Fixing | efficiency | | (Graininess, | tone | tone | color | bluish |
| set No. | ability | (%) | Anti-filming ability | uniformity) | image | image | code | color code |
| 55 | 95° C. | 98 | 1100 thousandth sheet | A | A | A | 7 colors | 9 colors |
| 56 | 95° C. | 99 | 1100 thousandth sheet | A | A | A | 7 colors | 9 colors |
| 57 | 95° C. | 98 | 1100 thousandth sheet | A | A | A | 7 colors | 9 colors |
| 58 | 95° C. | 98 | 1100 thousandth sheet | A | A | B | 7 colors | 9 colors |
| 59 | 95° C. | 97 | 1100 thousandth sheet | A | B | A | 7 colors | 9 colors |
| 60 | 95° C. | 94 | 900 thousandth sheet | C | D | D | 5 colors | 5 colors |
| 61 | 95° C. | 92 | 900 thousandth sheet | D | C | D | 5 colors | 6 colors |
| 62 | 95° C. | 93 | 900 thousandth sheet | C | D | D | 5 colors | 5 colors |
| 63 | 95° C. | 90 | 900 thousandth sheet | A | C | A | 7 colors | 6 colors |
| 64 | 95° C. | 91 | 900 thousandth sheet | A | C | B | 7 colors | 6 colors |
| 65 | 95° C. | 90 | 900 thousandth sheet | A | C | B | 7 colors | 6 colors |
| 66 | 95° C. | 96 | 900 thousandth sheet | A | A | B | 5 colors | 9 colors |
| 67 | 95° C. | 94 | 700 thousandth sheet | B | B | B | 4 colors | 9 colors |
| 68 | 95° C. | 95 | 700 thousandth sheet | B | B | B | 4 colors | 9 colors |
| 69 | 95° C. | 94 | 600 thousandth sheet | B | B | B | 7 colors | 9 colors |
| 70 | 100° C. | 79 | 1000 thousandth sheet | D | D | D | 7 colors | 5 colors |
| 71 | 95° C. | 96 | 1100 thousandth sheet | B | A | B | 7 colors | 9 colors |
| 72 | 95° C. | 95 | 1100 thousandth sheet | B | B | A | 7 colors | 9 colors |

TABLE 9 (5)

| | | | | Halftone | Graininess | | Color reproduction | |
|---|---|---|---|---|---|---|---|---|
| | | Transfer | | image | soft | dull | greenish | dark |
| Developer | Fixing | efficiency | | (Graininess, | tone | tone | color | bluish |
| set No. | ability | (%) | Anti-filming ability | uniformity) | image | image | code | color code |
| 73 | 90° C. | 97 | 900 thousandth sheet | A | A | A | 7 colors | 9 colors |
| 74 | 90° C. | 98 | 900 thousandth sheet | A | A | A | 7 colors | 9 colors |
| 75 | 90° C. | 98 | 900 thousandth sheet | A | A | A | 7 colors | 9 colors |
| 76 | 90° C. | 98 | 900 thousandth sheet | A | A | B | 7 colors | 8 colors |
| 77 | 90° C. | 99 | 900 thousandth sheet | A | B | A | 7 colors | 8 colors |
| 78 | 90° C. | 92 | 900 thousandth sheet | C | D | C | 5 colors | 6 colors |
| 79 | 90° C. | 91 | 900 thousandth sheet | D | C | D | 5 colors | 6 colors |
| 80 | 90° C. | 93 | 900 thousandth sheet | C | D | D | 5 colors | 6 colors |
| 81 | 90° C. | 90 | 900 thousandth sheet | B | C | A | 7 colors | 6 colors |
| 82 | 90° C. | 93 | 900 thousandth sheet | B | C | B | 7 colors | 6 colors |
| 83 | 90° C. | 90 | 900 thousandth sheet | B | C | B | 7 colors | 6 colors |
| 84 | 90° C. | 96 | 900 thousandth sheet | A | A | B | 5 colors | 9 colors |
| 85 | 90° C. | 90 | 700 thousandth sheet | B | B | B | 4 colors | 9 colors |
| 86 | 90° C. | 90 | 700 thousandth sheet | B | B | B | 4 colors | 9 colors |
| 87 | 90° C. | 94 | 500 thousandth sheet | B | B | B | 7 colors | 9 colors |
| 88 | 95° C. | 74 | 900 thousandth sheet | D | D | D | 7 colors | 5 colors |
| 89 | 90° C. | 95 | 900 thousandth sheet | A | A | B | 7 colors | 9 colors |
| 90 | 90° C. | 95 | 900 thousandth sheet | A | B | A | 7 colors | 9 colors |

TABLE 9 (6)

| | | | | Halftone | Graininess | | Color reproduction | |
|---|---|---|---|---|---|---|---|---|
| | | Transfer | | image | soft | dull | greenish | dark |
| Developer | Fixing | efficiency | | (Graininess, | tone | tone | color | bluish |
| set No. | ability | (%) | Anti-filming ability | uniformity) | image | image | code | color code |
| 91 | 95° C. | 87 | 250 thousandth sheet | B | C | B | 5 colors | 6 colors |
| 92 | 95° C. | 88 | 300 thousandth sheet | B | C | B | 5 colors | 6 colors |
| 93 | 95° C. | 84 | 310 thousandth sheet | B | C | B | 5 colors | 6 colors |
| 94 | 95° C. | 80 | 480 thousandth sheet | C | D | C | 4 colors | 5 colors |
| 95 | 95° C. | 81 | 510 thousandth sheet | D | C | D | 4 colors | 5 colors |
| 96 | 100° C. | 76 | 540 thousandth sheet | C | D | D | 4 colors | 5 colors |

TABLE 9 (7)

| | | | | Halftone | Graininess | | Color reproduction | |
|---|---|---|---|---|---|---|---|---|
| | | Transfer | | image | soft | dull | greenish | dark |
| Developer | Fixing | efficiency | | (Graininess, | tone | tone | color | bluish |
| set No. | ability | (%) | Anti-filming ability | uniformity) | image | image | code | color code |
| 97 | 120° C. | 97 | 900 thousandth sheet | B | C | B | 6 colors | 6 colors |
| 98 | 120° C. | 98 | 900 thousandth sheet | B | B | B | 6 colors | 6 colors |
| 99 | 120° C. | 98 | 900 thousandth sheet | B | C | C | 6 colors | 6 colors |
| 100 | 120° C. | 98 | 900 thousandth sheet | C | C | C | 5 colors | 6 colors |
| 101 | 120° C. | 99 | 900 thousandth sheet | C | C | C | 5 colors | 6 colors |
| 102 | 125° C. | 74 | 700 thousandth sheet | C | D | D | 5 colors | 5 colors |

1. A set of color toners comprising a yellow toner, a magenta toner, a cyan toner and a black toner,
wherein each of the color toners contains a colored particle and cerium oxide particles, the colored particle containing an amorphous polyester resin, a crystalline polyester resin, a colorant and a releasing agent; and
the colorant of the yellow toner contains C.I. Pigment Yellow 74, the colorant of the magenta toner contains C.I. Pigment Red 122 and C.I. Pigment Red 238, the colorant of the cyan toner contains any one of C.I. Pigment Blue 15:1, C.I. Pigment Blue 15:2 and C.I. Pigment Blue 15:3, and the colorant of the black toner contains carbon black and any one of C.I. Pigment Blue 15:1, C.I. Pigment Blue 15:2 and C.I. Pigment Blue 15:3.

2. The set of color toners of claim 1, wherein at least one of the color toners have a core-shell structure.

3. The set of color toners of claim 2, wherein the core contains the crystalline polyester resin and the amorphous polyester resin.

4. The set of color toners of claim 1, wherein the crystalline polyester resin is a polymer of a dicarboxylic acid and an aliphatic diol.

5. The set of color toners of claim 4, wherein the dicarboxylic acid is a straight chain aliphatic dicarboxylic acid.

6. The set of color toners of claim 4, wherein the aliphatic diol is a straight chain aliphatic diol having 2 to 22 carbon atoms composing its back bone chain.

7. The set of color toners of claim 4, wherein a melting point of crystalline polyester resin is 60 to 98° C.

8. The set of color toners of claim 7, wherein a melting point of crystalline polyester resin is 70 to 92° C.

9. The set of color toners of claim 1, wherein a content of the crystalline polyester resin is 1 to 40% by weight based on the colored particle.

10. The set of color toners of claim 1, wherein the crystalline polyester resin has a molecular weight of 3,000 to 20,000.

11. The set of color toners of claim 1, wherein the crystalline polyester resin has a molecular weight of 11,000 to 19,000.

12. The set of color toners of claim 1, wherein molar ratio of the crystalline polyester to the amorphous polyester in the toner is 2:98 to 60:40.

13. The set of color toners of claim 1, wherein a molar ratio of the crystalline polyester to the amorphous polyester in the toner is 5:95 to 50:50.

14. The set of color toners of claim 1, wherein a glass transition temperature of the amorphous polyester resin is 51.1 to 65.0° C.

15. The set of color toners of claim 1, wherein the amorphous polyester resin has a molecular weight of 3,000 to 22,000.

16. The set of color toners of claim 1, wherein the amorphous polyester resin has a molecular weight of 10,000 to 20,000.

17. The set of color toners of claim 1, wherein the releasing agent is a synthesis wax having a melting point of 70 to 95° C.

18. The set of color toners of claim 1, wherein the releasing agent is paraffin wax having a melting point of 70 to 100° C.

19. The set of color toners of claim 1, wherein the releasing agent is Fischer-Tropsch wax having a melting point of 75 to 100° C.

20. The set of color toners of claim 1, wherein a number average particle diameter of cerium oxide particle is 150 to 800 nm.

21. The set of color toners of claim 20, wherein number average particle diameter of cerium oxide particle is 250 to 700 nm.

22. The set of color toners of claim 1, wherein a content of the cerium oxide particles is 0.5 to 3.5% by weight based on total weight of the toner.
